(19) United States
(12) Patent Application Publication
(10) Pub. No.: US 2022/0026728 A1
(43) Pub. Date: Jan. 27, 2022

(54) OPTICAL DEVICES AND METHODS

(71) Applicant: Oxford University Innovation Limited, Oxford (Oxfordshire) (GB)

(72) Inventors: Martin BOOTH, Oxford (Oxfordshire) (GB); Chao HE, Oxford (Oxfordshire) (GB)

(21) Appl. No.: 17/311,371

(22) PCT Filed: Dec. 9, 2019
(86) PCT No.: PCT/GB2019/053475

§ 371 Date: Jun. 7, 2021

(30) Foreign Application Priority Data
Dec. 10, 2018 (GB) 1820088.1

(51) Int. Cl. G02B 27/28; G02B 5/30; G02B 3/00

(52) U.S. Cl. CPC G02B 27/286; G02B 3/0087; G02B 5/3083

(57) ABSTRACT

An apparatus (100, 300, 400, 500) for generating vector vortex beams (VVB) that comprise non-uniform polarization states and orbital angular momentum (OAM), the apparatus comprising: a light source (102) arranged to provide a source field (104); a polarization state generator (106, 402, 502), PSG, arranged to manipulate the source field to provide a modified field (108) having a single polarization state; and a transformation module (110, 200, 404, 504) arranged to receive the modified field from the PSG and transform it to provide an output field (112), wherein the transformation module comprises a cascade of gradient-index, GRIN, lenses (202, 204, 206, 408, 508).

### TECHNICAL FIELD

The present disclosure relates to a method and apparatus for generating vector vortex beams (VVB) that have non-uniform polarization states and contain orbital angular momentum (OAM), and a method and apparatus for generating OAM beams that have uniform polarization states.

### BACKGROUND

A mode of light can generally be characterized by four parameters: amplitude, wavelength, phase and polarization. The investigation and application of vector fields, as opposed to scalar fields, is of increasing interest. Known phase modulation and polarization modulation devices include deformable mirrors, spatial light modulators (SLM), photo-elastic modulators, q-plates, j-plates, conical intra-cavity prisms, vortex phase plates, multi-mode fibres and so on. Some of these can do pure phase modulation, whilst others can do both phase and polarization modulation. However, many of these devices pose drawbacks, such as being relatively expensive, unstable in operation, or even infeasible in practice.

The project leading to this application has received funding from the European Research Council (ERC) under the European Union's Horizon 2020 research and innovation programme (grant agreement No 695140).

Accordingly it is an object of the present disclosure to provide alternative devices and techniques for performing spatial phase and polarization modulation of light.

### SUMMARY OF DISCLOSURE

According to a first aspect of the disclosure there is provided an apparatus for generating vector vortex beams (VVB) that comprise non-uniform polarization states and orbital angular momentum (OAM), the apparatus comprising:
a light source arranged to provide a source field;
a polarization state generator, PSG, arranged to manipulate the source field to provide a modified field having a single polarization state; and
a transformation module arranged to receive the modified field from the PSG and transform it to provide an output field, wherein the transformation module comprises a cascade of gradient-index, GRIN, lenses.

The inherent gradually-changing birefringence properties of a GRIN lens can be exploited to generate vector vortex beams (VVB) that comprise non-uniform polarization states and contain orbital angular momentum (OAM). In addition, the GRIN lens can still perform an imaging function in addition to the polarization and phase manipulation. It is therefore a very versatile arrangement well-suited to integration in optical fibre probes, for example. It should be noted that the GRIN lens modulated light field is advantageous because the light field profile is well-symmetric benefiting from the stable gradually changing birefringence profile of the GRIN lens. Further, cascaded GRIN lens structures are suitable for use in various compact and robust minimized integrated optics devices, taking advantage of the quality of the rod-like GRIN lens itself, i.e., smaller volume, stable and suitable for coupling with other optical components.

The transformation module transforms the modified field by transmitting it through the components of the transformation module, such as the cascade of GRIN lenses and any interstitial components, to provide the output field at the output of the cascade of GRIN lenses. In this manner the modified field is subject to the birefringence profile of the one or more GRIN lenses and is thereby transformed.

The PSG may comprise an input linear polarizer. The PSG may further comprise an input quarter wave plate, QWP. A QWP can advantageously be used to generate circular or elliptical polarization states of light or to analyse circular or elliptical polarization states of light when used in an analyser, such as a PSA disclosed herein.

The transformation module may further comprise a spatially-variant half wave plate, SHWP, arranged before the cascade of GRIN lenses and after the PSG. In this manner the SHWP is one such interstitial component.

The SHWP may be arranged to act on the modified field to provide a field having a plurality of spatial portions, each having a different polarization state, prior to the cascade of GRIN lens. This may enable the generation of more complex VVBs by having different polarization states incident on different regions of the cascade of GRIN lenses.

The SHWP may be arranged to provide a field having a first spatial portion with horizontal polarization, a second spatial portion with vertical polarization, a third spatial portion with +45 degrees polarization and a fourth spatial portion with −45 degrees polarization.

The SHWP may be arranged to receive (i.e. be illuminated by) a field from the PSG having a first spatial portion with horizontal polarization, a second spatial portion with vertical polarization, a third spatial portion with +45 degrees polarization and a fourth spatial portion with −45 degrees polarization.

The apparatus may further comprise a polarization state analyser, PSA, arranged to select a single polarization state of the output field.

The PSA may comprise an output QWP and an output linear polarizer. A QWP and linear polarizer combination is able to analyse elliptical and circular polarization states of light.

The cascade of GRIN lenses may additionally comprise one or more interstitial components either between at least one pair of GRIN lenses in the cascade of GRIN lenses and/or before the cascade of GRIN lenses and/or after the cascade of GRIN lenses.

The one or more interstitial components may comprise one or more of: a quarter wave plate; a half wave plate; a spatially-variant half wave plate; a vector phase plate; and a four quadrant quarter wave plate array with four different fast axis orientations.

The cascade of GRIN lenses may comprise a pair of GRIN lenses having substantially equal birefringence profiles.

The cascade of GRIN lenses may comprise a first and second GRIN lens. The first and second GRIN lenses may have different birefringence profiles. The second GRIN lens may provide three times as much retardance as the first GRIN lens.

The light source may be a light emitting diode, LED, or a laser. The light source may comprise a spectral filter.

The PSG may be arranged to provide a modified field with right-hand circular polarization or left hand-circular polarization and the PSA may be arranged to select left-hand circular polarization or right-hand circular polarization respectively.

According to a second aspect of the disclosure there is provided a method of generating vector vortex beams (VVB) that comprise non-uniform polarization states and orbital angular momentum (OAM), the method comprising:
generating a light source field;
at a polarization state generator, PSG, manipulating the source field to provide a modified field having a single polarization state; and
at a transformation module, receiving the modified field from the PSG and transforming it to provide an output field, wherein the transformation module comprises a cascade of gradient-index, GRIN, lenses.

The transformation module may comprise a spatially-variant half wave plate, SHWP, which acts on the modified field to provide a field having a plurality of spatial portions, each having a different polarization state, prior to the cascade of GRIN lens.

The SHWP may be arranged to be illuminated by a field having a first spatial portion with horizontal polarization, a second spatial portion with vertical polarization, a third spatial portion with +45 degrees polarization and a fourth spatial portion with −45 degrees polarization.

The SHWP may provide a field having a first spatial portion with horizontal polarization, a second spatial portion with vertical polarization, a third spatial portion with +45 degrees polarization and a fourth spatial portion with −45 degrees polarization, prior to the cascade of GRIN lenses.

The method may further comprise, at a polarization state analyser, PSA, selecting a single polarization state of the output field.

The method may further comprise providing, from the PSG, a modified field with right-hand circular polarization or left-hand circular polarization. The PSA may select left-hand circular polarization or right-hand circular polarization.

According to a third aspect of the disclosure there is provided an apparatus for generating vector vortex beams (VVB) that comprise non-uniform polarization states and orbital angular momentum (OAM), the apparatus comprising:
a light source arranged to provide a source field;
a polarization state generator, PSG, arranged to manipulate the source field to provide a modified field having a single polarization state; and
a transformation module arranged to receive the modified field from the PSG and transform it to provide an output field, wherein the transformation module comprises a gradient-index, GRIN, lens and a spatially-variant half wave plate, SHWP, arranged between the GRIN lens and the PSG.

According to a fourth aspect of the disclosure there is provided a method of generating vector vortex beams (VVB) that comprise non-uniform polarization states and orbital angular momentum (OAM), the method comprising:
generating a light source field;
at a polarization state generator, PSG, manipulating the source field to provide a modified field having a single polarization state; and
at a transformation module, receiving the modified field from the PSG and transforming it to provide an output field, wherein the transformation module comprises a gradient-index, GRIN, lens and a spatially-variant half wave plate, SHWP, arranged between the GRIN lens and the PSG.

According to an fifth aspect of the disclosure there is provided an apparatus for generating orbital angular momentum (OAM) beams that have uniform polarization states, the apparatus comprising:
a light source arranged to provide a source field;
a polarization state generator, PSG, arranged to manipulate the source field to provide a modified field having a single polarization state;
a transformation module arranged to receive the modified field from the PSG and transform it to provide an output field, wherein the transformation module comprises a gradient-index, GRIN, lens; and
a polarization state analyser, PSA, arranged to select a polarization state of the output field which is different from the polarization state of the modified field:

The PSA may be arranged to select a polarization state of the output field which has the opposite handedness to the polarization state of the modified field generated by the PSG

The transformation module may comprise a cascade of GRIN lenses. The transformation module may further comprise one or more interstitial components as defined herein.

The PSG may be arranged to provide a modified field having a left-hand circular polarization state or a right-hand circular polarization state and the PSA may be arranged to select a right-hand circular polarization state of the output field when the PSG is arranged to provide a left-hand circular polarization state; or a left-hand circular polarization state of the output field when the PSG is arranged to provide a right-hand circular polarization state. Advantageously, this arrangement of right/left-hand polarization state generation by the PSG and respective left/right-hand polarization state selection by the PSA gives rise to an optimal amount of spin to orbital angular momentum conversion, although it should be appreciated that other generated and analysed polarization states can still give rise to generated OAM, e.g. provided the analysis polarization state selected by the PSA is in general different from the incident polarization state generated by the PSG.

According to a sixth aspect of the disclosure there is provided a method of generating orbital angular momentum (OAM) beams that have uniform polarization states, the method comprising:
generating a light source field;
at a polarization state generator, PSG, manipulating the source field to provide a modified field having a single polarization state;
at a transformation module, receiving the modified field from the PSG and transforming it to provide an output field, wherein the transformation module comprises a gradient-index, GRIN, lens; and
at a polarization state analyser, PSA, selecting a polarization state of the output field which is different from the polarization state of the modified field.

The PSA may select a polarization state of the output field which has the opposite handedness to the polarization state of the modified field generated by the PSG.

The PSG may provide a source field having a left-hand circular polarization state or a right-hand circular polarization state and the PSA may select a right-hand circular polarization state of the output field when the PSG provides a left-hand circular polarization state; or a left-hand circular polarization state of the output field when the PSG provides a right-hand circular polarization state. For example, if the PSA comprises a quarter wave plate followed by the linear polarizer and the PSG comprises a linear polarizer followed by a quarter wave plate then the two linear polarizers may be fixed at 0 degrees and the quarter wave plates may be fixed at 45 degrees, although other relative orientations may also be selected.

The features (including optional features) of any aspect may be combined with those of any other aspect, as appropriate.

### BRIEF DESCRIPTION OF THE DRAWINGS

Example embodiments will be described, by way of example only, with reference to the drawings, in which:

FIG. 1 is a block diagram of an apparatus for generating vector vortex beams (VVB) having non-uniform polarization states and containing orbital angular momentum (OAM), or generating OAM beams that have uniform polarization states;

FIG. 2 is a schematic illustration of a transformation module of an apparatus for generating VVBs having non-uniform polarization states and containing OAM, or generating OAM beams that have uniform polarization states;

FIG. 3 is a schematic illustration of an exemplary apparatus for generating VVBs having non-uniform polarization states and containing OAM, or generating OAM beams that have uniform polarization states;

FIG. 4 is a schematic illustration of a further exemplary apparatus for generating VVBs having non-uniform polarization states and containing OAM;

FIG. 5 is a schematic illustration of a further exemplary apparatus for generating VVBs having non-uniform polarization states and containing OAM;

FIGS. 6a to 6e show experimental results and simulations showing the polarization states contained in various VVBs generated by an apparatus such as that illustrated in FIG. 4;

FIG. 7 shows experimental results and simulations showing the polarization states contained in various VVBs generated by an apparatus such as that illustrated in FIG. 5;

FIG. 8 is an analysis of an experimentally generated full Poincaré beam;

FIGS. 9a to 9j show a number of further experimental results of the polarization states contained in VVBs generated using apparatuses according to the present disclosure;

FIG. 10 is a selection of six generated polarization patterns corresponding to experimentally generated vector vortex beams;

FIG. 11 is a pathway of changing analysis polarization states illustrated on the Poincaré sphere for analysing a beam having a uniform polarization state and orbital OAM generated using an apparatus according to the present disclosure;

FIGS. 12a to 12d are experimental results and simulations for OAM beam generation at each of the analysis polarization states illustrated on the Poincaré sphere of FIG. 11;

FIG. 13 is an exemplary experimental setup used to obtain the interference patterns shown in FIGS. 12a to 12d;

FIGS. 14 to 16 are further experimental results of phase modulation;

FIG. 17 is an exemplary single-shot Mueller matrix polarimeter which operates in transmission mode;

FIGS. 18 and 19 show experimental and theoretical properties of the Mueller matrix polarimeter;

FIG. 20 is an experimental setup for testing the Mueller matrix polarimeter;

FIGS. 21 and 22 show experimental reconstruction of Mueller matrix elements and comparison with theoretical predictions for a number of different dynamic samples;

FIG. 23 shows an alternative single-shot Mueller matrix polarimeter which operates in a backscattering configuration;

FIG. 24 shows the salient optical components of a fibre-based single-shot Mueller matrix polarimeter; and

FIGS. 25 to 28 show various properties of a GRIN lens.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION

The gradient-index (GRIN) lens is a rigid rod-like imaging lens, which generally has a gradient refractive index profile and flat surfaces to guide light via a cosine ray trace. During the fabrication of GRIN lenses, the ion-exchange process introduces stresses along the radial direction of the GRIN lens rod and induces an intrinsic birefringence, which is usually treated as an unwanted, negative side-effect. However, according to the present disclosure, the gradually changing profile of this intrinsic birefringence is exploited to provide a spatial modulator for both absolute phase and polarization, whilst retaining the imaging capability of the GRIN lens. Further descriptions of the GRIN lens are provided towards the end of the description.

Vector Vortex Beam Generation

Vector vortex beams (VVBs) possess both vector polarization and helical phase. Such beams may have application in complex light beam engineering, as well as enabling modification of the shape of a beam focus for e.g. microscopy, for super-resolution applications, or can be used to demonstrate Moebius band-like topologies. One type of vector beam called a full Poincaré beam, which is named by its unique characteristic of containing all of the polarization states on the Poincaré sphere, is receiving increasing research attention due to promising applications.

The following description discusses the generation and validation of the full Poincaré beam, according to aspects of the present disclosure. The inner, gradually-changing birefringence property of the GRIN lens could be thought of as being equivalent to a spatially-variant wave plate array with gradually increasing linear retardance along the radial direction and which contains all the fast axis directions twice along the azimuthal direction. As such, the GRIN lens can be described in the Jones Matrix representation as:

$${J}_{GRIN} = [ \begin{matrix}{sin}^{2} ( θ ) + ϵ {cos}^{2} ( θ ) & ( ϵ - 1 ) sin ( θ ) cos ( θ ) \\ ( ϵ - 1 ) sin ( θ ) cos ( θ ) & {cos}^{2} ( θ ) + ϵ {sin}^{2} ( θ )\end{matrix} ] \qquad ( 1 )$$

where ∈=e^{iσ}=cos(σ)+i sin(σ), and σ=f(r)∝nₑ(r) which is the retardance profile of the target retarder. Here θ is the fast axis direction of the equivalent wave plate which equals to the azimuthal angle in the cylindrical-coordinate system, r is the radius of the section of GRIN lens, σ is the linear retardance value of the equivalent wave plate at the fixed r and θ. Suppose an incident polarization state Jᵢₙ=[cos ϕ, e^{iδ} sin ϕ]^{T} impinges on every point on the GRIN lens cross section. This state is determined by a specific angle ϕ of two components compared with the horizontal direction and a retardance (phase) δ between two components. The output polarization state Jₒᵤₜ can be easily yielded by Jₒᵤₜ=J_{GRIN}·Jᵢₙ according to the usual Jones calculus. Taking advantage of the unique gradually-changing birefringence profile (both linear retardance and azimuthal varying orientations) of the GRIN lens, the inventor has appreciated that arrangements employing one or more GRIN lenses, and optionally other optical components in addition, are able to generate various vector vortex beams when choosing different incident states of polarization.

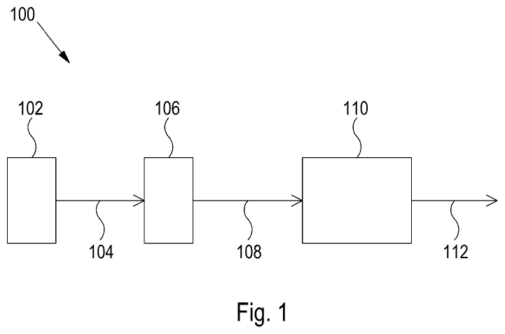

FIG. 1 illustrates schematically an apparatus 100 for 1) generating VVBs that have non-uniform polarization states and contain OAM, or 2) generating OAM beams that have a uniform polarization state. according to the present disclosure. The apparatus comprises a light source 102 which is arranged to provide a source field 104, a polarization state generator 106 (PSG) which is arranged to manipulate the source field to provide a modified field 108 having a single polarization state; and a transformation module 110 which is arranged to receive the modified field from the PSG and transform it to provide an output field 112, wherein the transformation module comprises a cascade of (GRIN) lenses. The output field could be a vector vortex beam.

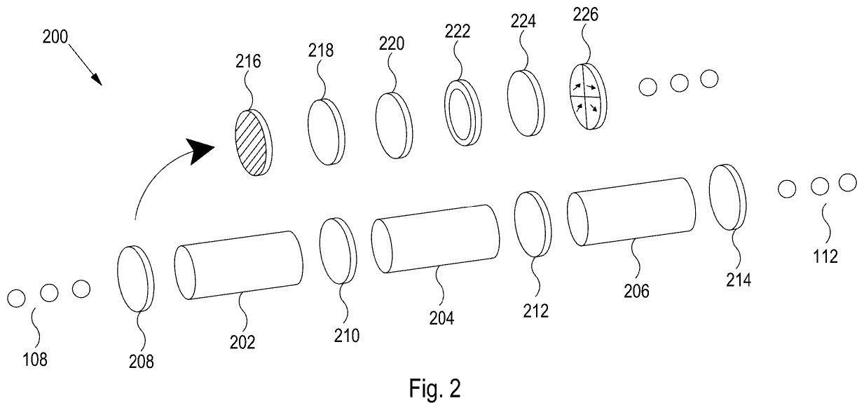

An exemplary transformation module 200 is illustrated in greater detail in FIG. 2. In general, it comprises a cascade of GRIN lenses 202, 204, 206, i.e. two or more GRIN lenses arranged in series, and one or more sets of interstitial components 208, 210, 212, 214. The sets of interstitial components may be between at least one pair of GRIN lenses in the cascade of GRIN lenses and/or before the cascade of GRIN lenses and/or after the cascade of GRIN lenses. In FIG. 2 there is a set of interstitial components (each of which may be just a single component) between each pair of adjacent GRIN lenses in addition to interstitial components before and after the cascade of GRIN lenses but alternative arrangements are also envisaged as described in greater detail below. Example interstitial components which may be employed in each set of interstitial components are: a linear polarizer 216 (LP), a quarter wave plate 218 (QWP), a half wave plate 220 (HWP); a spatially-variant half wave plate 222 (SHWP); a vector phase plate 224; and a four quadrant quarter wave plate array 226 (FQWP) with four different fast axis orientations.

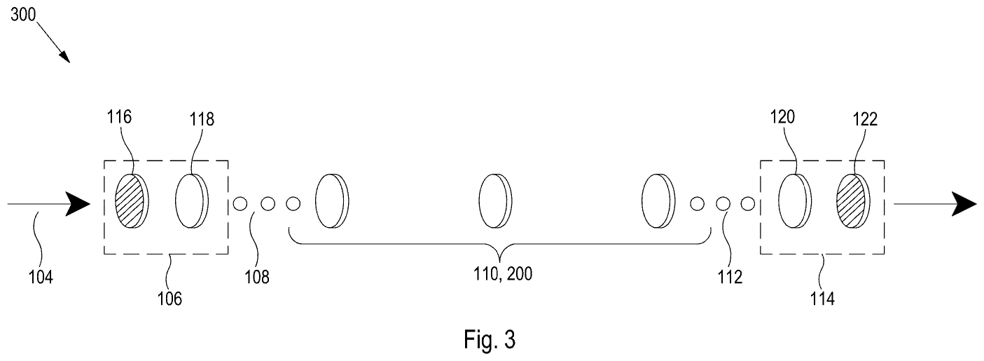

FIG. 3 illustrates schematically an exemplary apparatus 300 for 1) generating vector vortex beams (VVB) that have non-uniform polarization states and contain orbital angular momentum (OAM), or 2) generating OAM beams that have uniform polarization states. The apparatus comprises a PSG 106, and transformation module 110, 200 as above. In addition, the apparatus comprises a polarization state analyser 114 (PSA) after the transformation module which is arranged to select a single polarization state of the output field 112. According to this example, the PSA comprises an output QWP 120 and an output LP 122 arranged after the QWP. The PSG comprises an input LP 116 and an input QWP 118. In the case of VVB generation, the PSA is optional and usually only used to characterize the generated light since the VVB has non-uniform polarization states. In the case of OAM beam generation, the PSA is used to filter out a specific polarization state of light resulting in an OAM beam having a uniform polarization state.

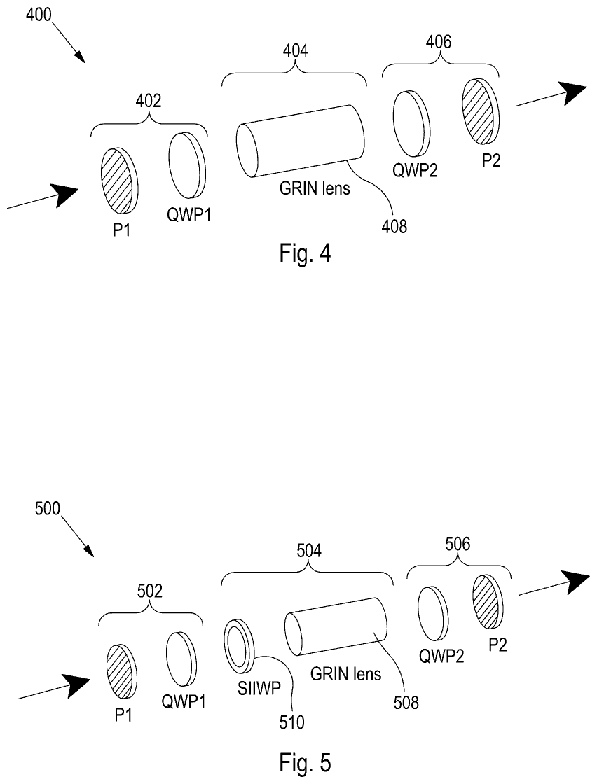

FIGS. 4 and 5 illustrate two further exemplary apparatuses 400 and 500 for 1) generating vector vortex beams (VVB) that have non-uniform polarization states and contain orbital angular momentum (OAM), or 2) generating OAM beams that have uniform polarization states. The apparatus 400 of FIG. 4 comprises a PSG 402 (in the form of a polarizer P1 followed by a quarter wave plate QWP1), transformation module 404, and PSA 406 (in the form of a quarter wave plate QWP1 followed by a polarizer P1). The transformation module 404 comprises a single GRIN lens 408 with no interstitial components. The apparatus 500 of FIG. 5 comprises a PSG 502, transformation module 504, and PSA 506. The transformation module 504 comprises a single GRIN lens 508 in combination with a spatially-variant half wave plate 510. It should be appreciated that the PSA may not be required in some applications, e.g. vector vortex beam generation, but can assist in the analysis of the generated beams and therefore may optionally be included, as mentioned above.

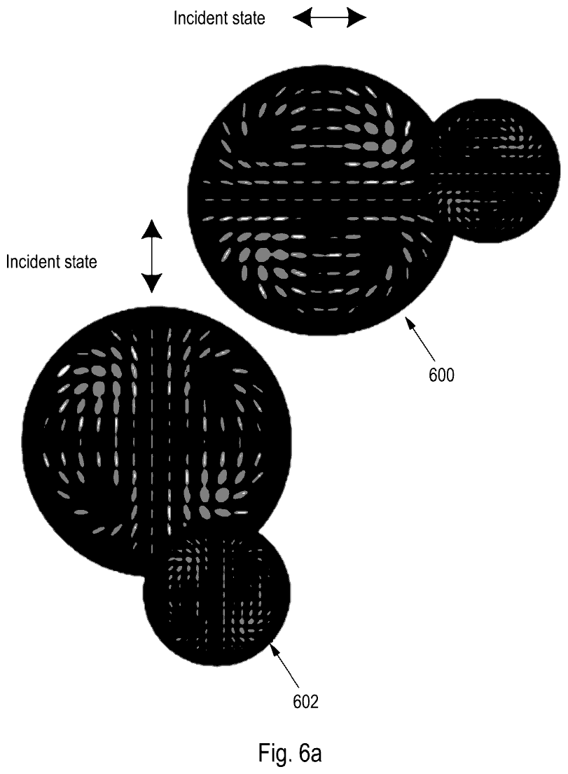

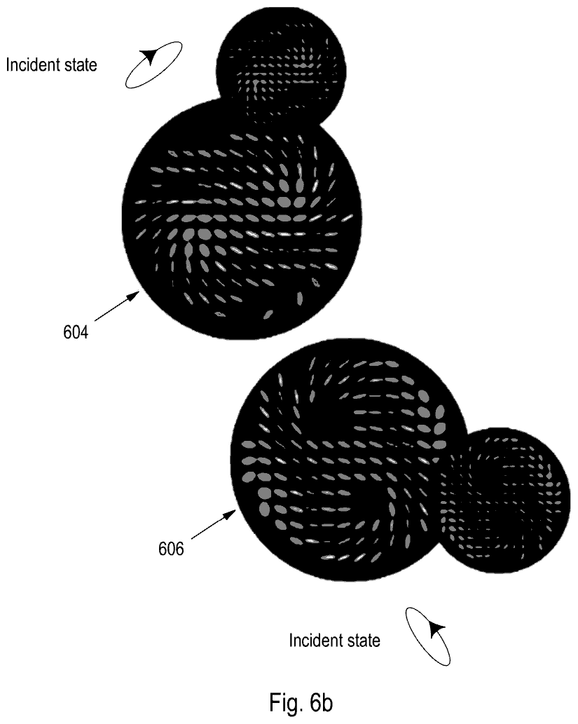

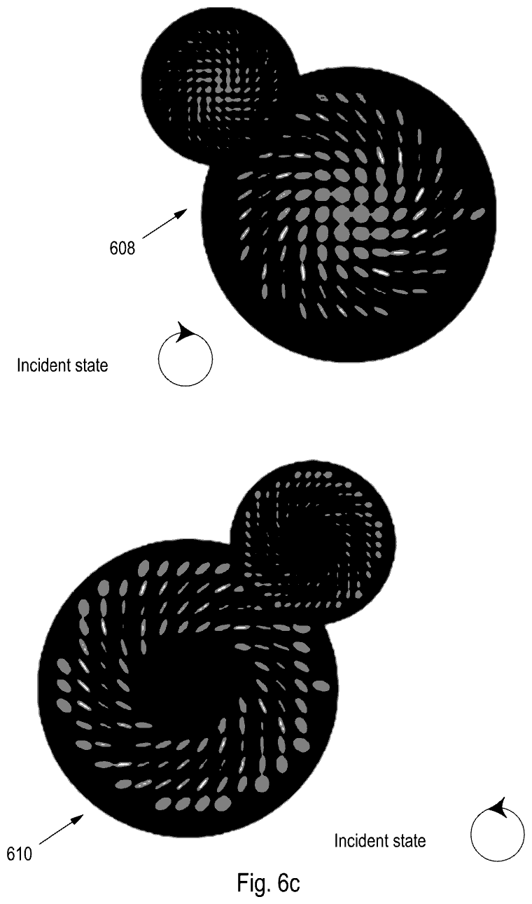

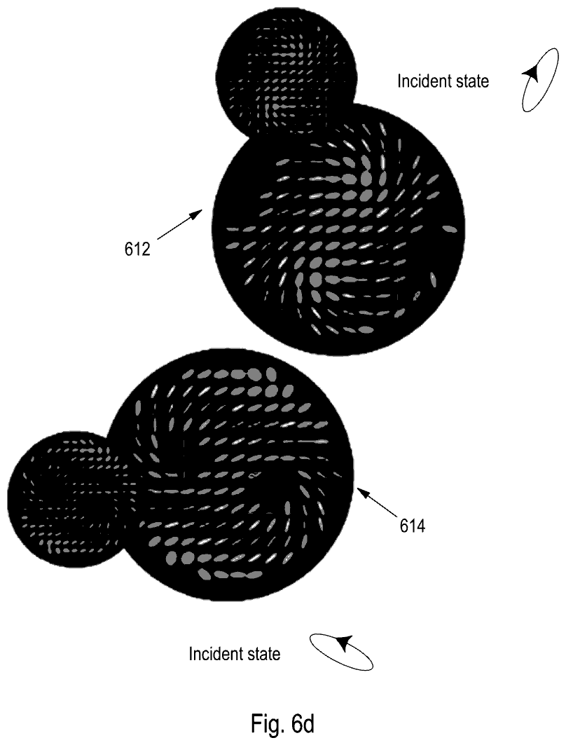

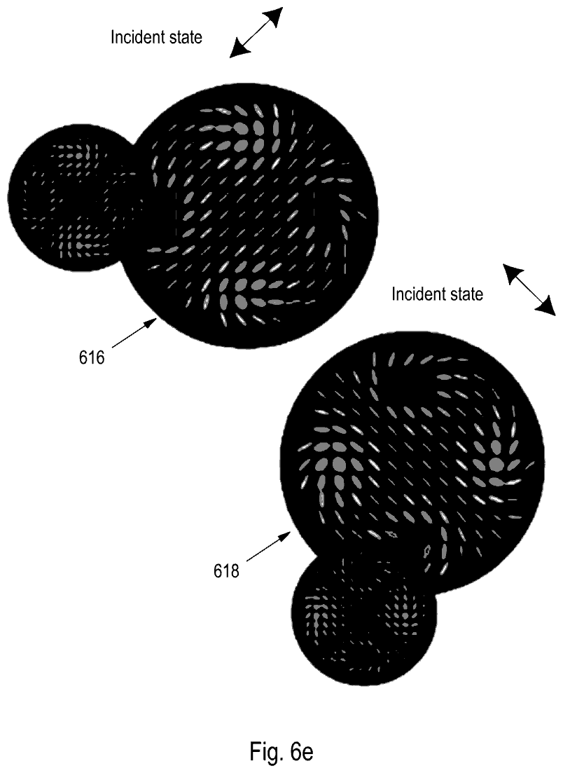

FIGS. 6a to 6e show experimental results and simulations corresponding to the polarization states contained in various vector vortex beams generated by a single GRIN lens transformation module, i.e. using an apparatus such as that described above with reference to FIG. 4, when having different polarization states generated by the PSG incident on the GRIN lens. The polarization states are defined with respect to the horizontal direction and they are: 0 and 90 degrees linearly polarized light (patterns 600 and 602 respectively in FIG. 6a), right hand and left hand elliptically polarized light with P1 at 0 degrees for both cases, QWP1 at 22.5 degree and −67.5 degree separately in the PSG (patterns 604 and 606 respectively in FIG. 6b), right and left hand circular polarized light (patterns 608 and 610 respectively in FIG. 6c), right hand and left hand elliptically polarized light with P1 at 0 degree for both cases, QWP1 at 67.5 degree and −22.5 degree separately in the PSG (patterns 612 and 614 respectively in FIG. 6d), and 45 and −45 degree linear polarized light (patterns 616 and 618 respectively in FIG. 6e). The red colour indicates a right hand circular polarization state, the blue colour indicates the left hand circular polarization state and the green colour indicates a linear polarization state. The light field patterns in the larger circles represent experimental results and the small circles are simulation counterparts. It should be noted that there is an excellent correspondence between the simulated results and the experimental results.

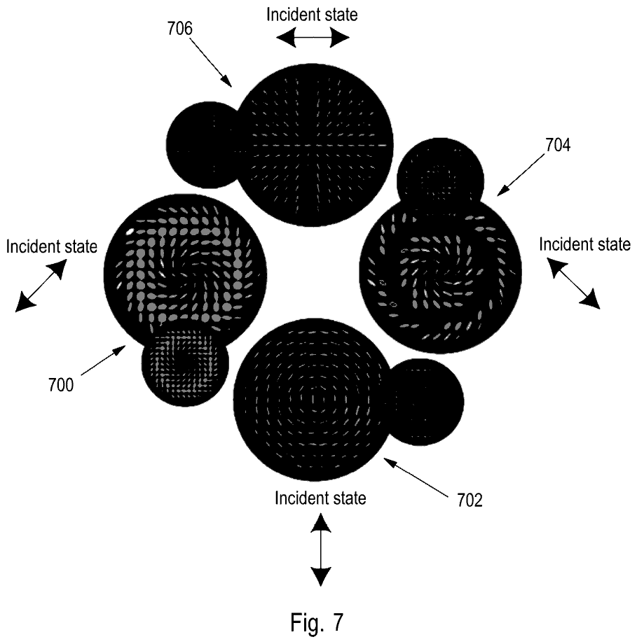

FIG. 7 shows experimental results and simulations corresponding to the polarization states contained in various vector vortex beams generated by a single GRIN lens transformation module having also a SHWP, i.e. using an apparatus such as that described above with reference to FIG. 5. Four incident polarization states are generated by the corresponding PSG, and the vector vortex beams are obtained after GRIN lens by the corresponding PSA.

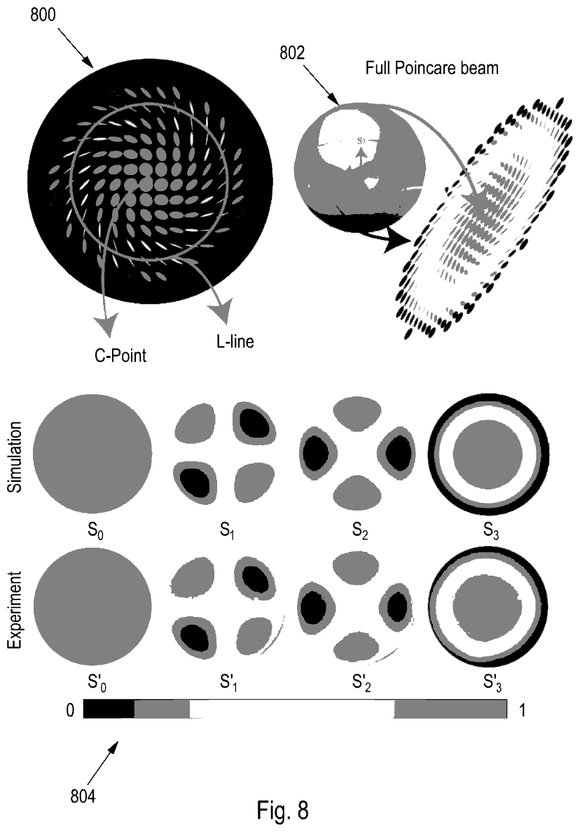

FIG. 8 shows an analysis of one full Poincaré beam 800 also shown as 608 in FIG. 6c. The C-point and L-line, as well as Poincaré sphere projection demonstration 802, validate the existence of a full Poincaré beam, i.e. all polarization states on the surface of the Poincaré sphere are present in the beam. The simulation (S0 to S3) and experimental results (S′0 to S′3) of the Stokes vectors of the full Poincaré beam are shown at 804 and demonstrate excellent correspondence. It should be appreciated that for any pure uniform incident polarization state incident, the single GRIN lens could generate a full Poincaré beam. For example, if the single GRIN lens has a birefringence which can induce a retardance of at least π radians then a full Poincaré beam can be generated. Alternatively, two or more separate GRIN lenses which together provide a net retardance of at least π radians may be used.

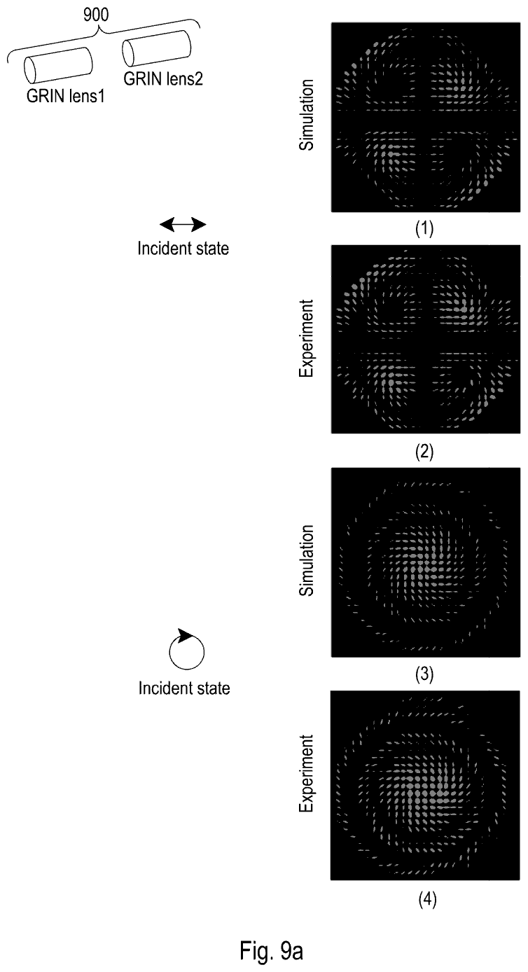

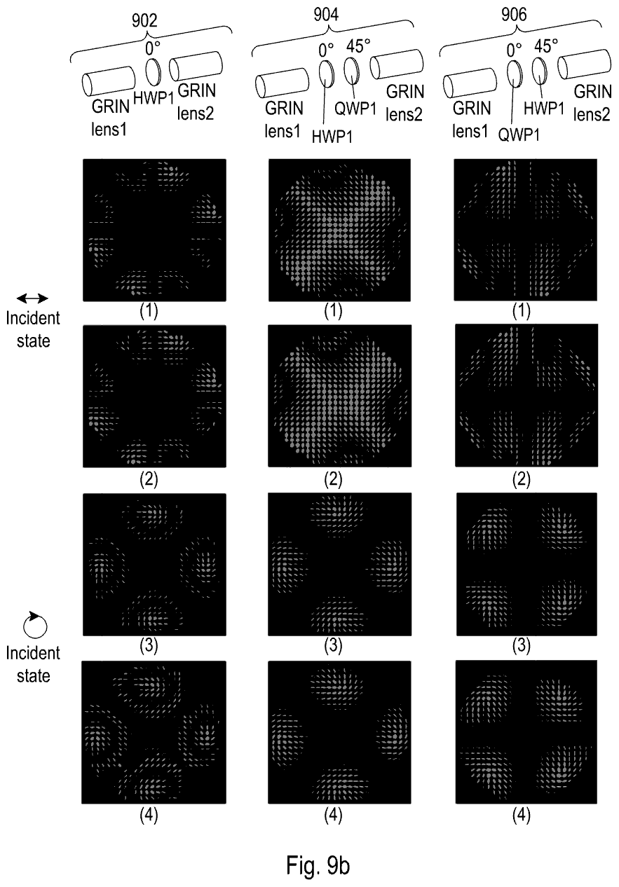

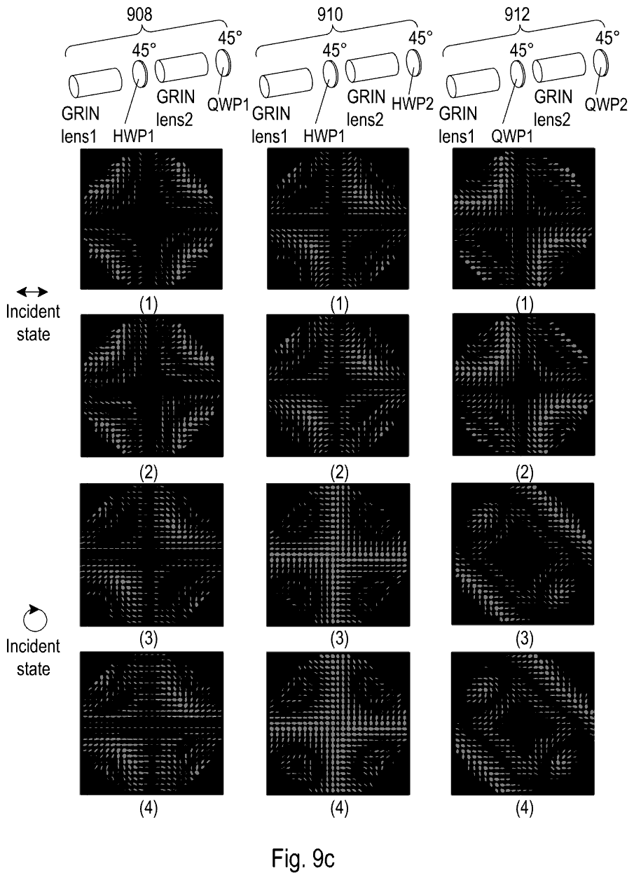

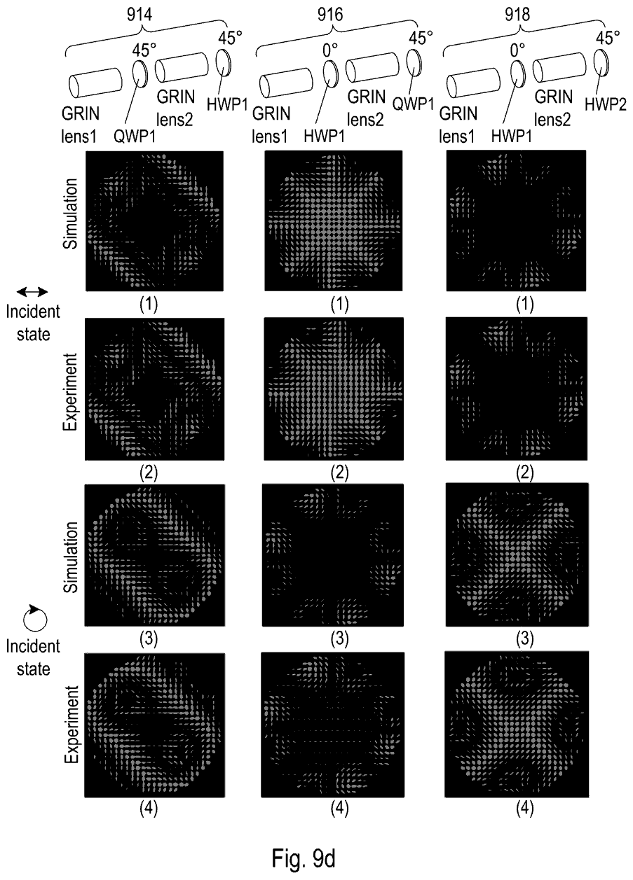

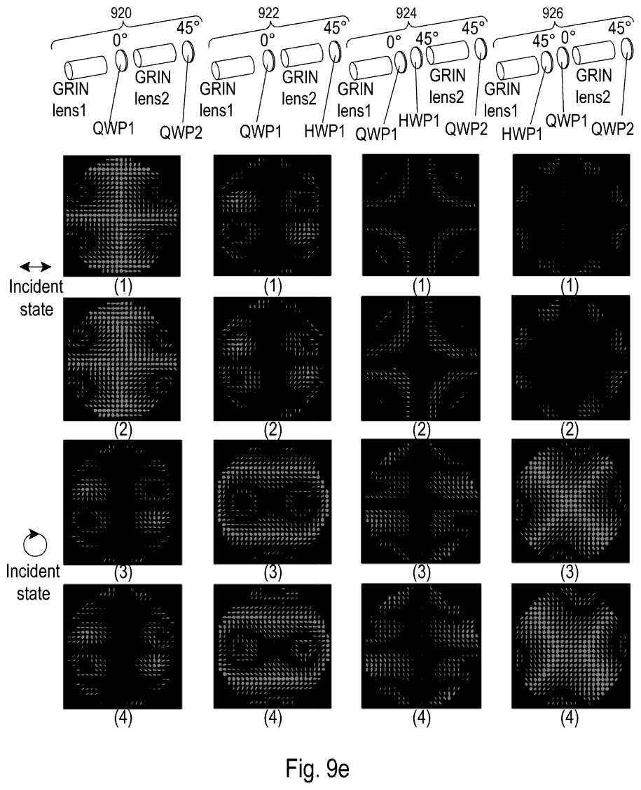

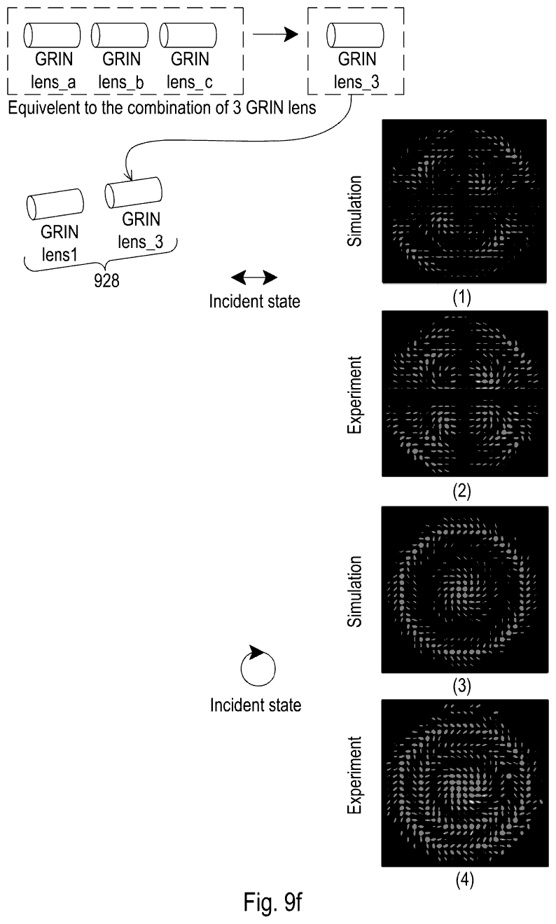

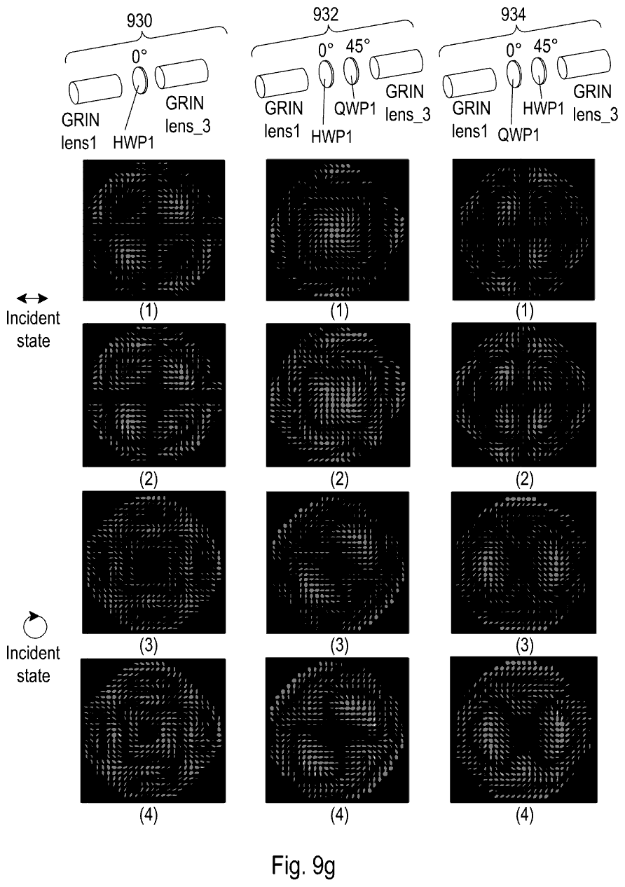

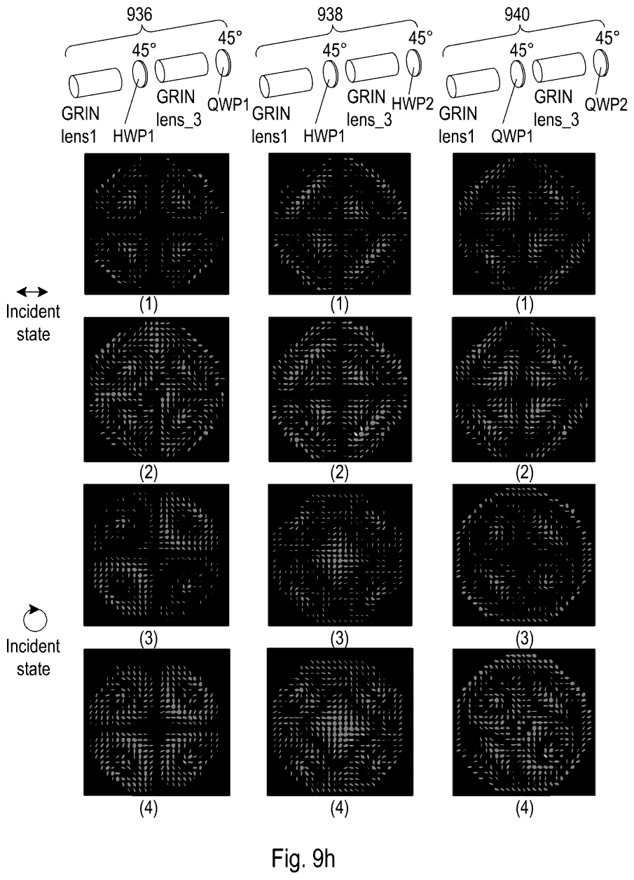

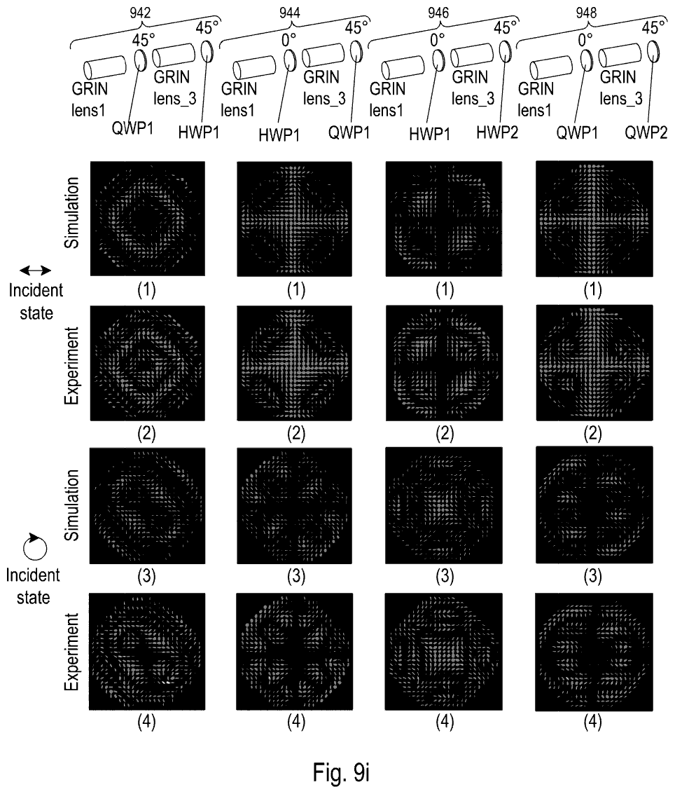

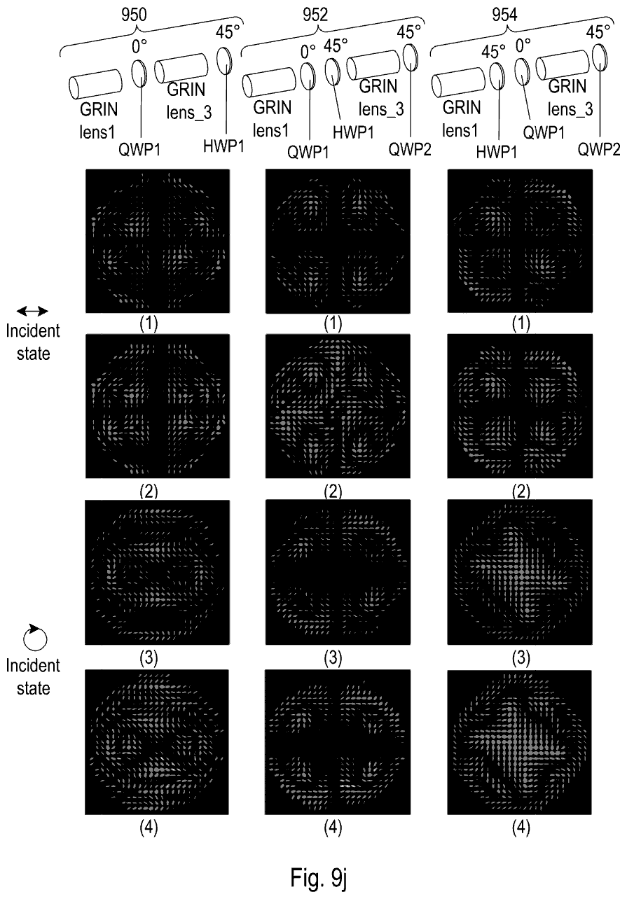

FIGS. 9a to 9j show a number of further experimental results corresponding to the polarization states contained in vector vortex beams generated using apparatuses according to the present disclosure. The PSG and PSA are not shown in FIGS. 9a to 9j but the layout may be similar to that shown in FIG. 3, where different transformation modules are used. Panels (2) and (4) in each of FIGS. 9a to 9j show experimentally-measured polarization states of the vector vortex beams produced for horizontally polarized and right-hand circularly polarized input states respectively generated by the PSG. Panels (1) and (3) show corresponding simulated results for comparison purposes.

In FIG. 9a, a transformation module 900 consists of a pair of GRIN lenses in a cascade, where the two GRIN lenses have the same birefringence profile and, optionally, are separated by a gap, e.g. free-space gap. In FIG. 9b, transformation module 902 consists of a pair of similar or same birefringence GRIN lenses in a cascade with an interstitial component in the form of a half wave plate HWP1 with a fast axis orientation at 0 degrees to the horizontal. Transformation module 904 consists of a pair of similar or same birefringence GRIN lenses in a cascade with an interstitial component in the form of a half wave plate HWP1 with a fast axis orientation at 0 degrees to the horizontal followed by a quarter wave plate QWP1 with a fast axis orientation at 45 degrees to the horizontal. Transformation module 906 consists of a pair of similar or same birefringence GRIN lenses in a cascade with an interstitial component in the form of a quarter wave plate QWP1 with a fast axis orientation at 45 degrees to the horizontal followed by a half wave plate HWP1 with a fast axis orientation at 0 degrees to the horizontal. In FIG. 9c, transformation module 908 consists of a pair of similar or same birefringence GRIN lenses in a cascade with an interstitial component in the form of a half wave plate HWP1 with a fast axis orientation at 45 degrees to the horizontal between the two GRIN lenses of the cascade followed by a quarter wave plate QWP1 with a fast axis orientation at 45 degrees to the horizontal after the second grin lens in the cascade. Transformation module 910 consists of a pair of similar or same birefringence GRIN lenses in a cascade with an interstitial component in the form of a half wave plate HWP1 with a fast axis orientation at 45 degrees to the horizontal between the two GRIN lenses of the cascade followed by a second half wave plate HWP2 with a fast axis orientation at 45 degrees to the horizontal after the second grin lens in the cascade. Transformation module 912 consists of a pair of similar or same birefringence GRIN lenses in a cascade with an interstitial component in the form of a quarter wave plate QWP1 with a fast axis orientation at 45 degrees to the horizontal between the two GRIN lenses of the cascade followed by a second quarter wave plate QWP2 with a fast axis orientation at 45 degrees to the horizontal after the second grin lens in the cascade. In FIG. 9d, transformation module 914 consists of a pair of similar or same birefringence GRIN lenses in a cascade with an interstitial component in the form of a quarter wave plate QWP1 with a fast axis orientation at 45 degrees to the horizontal between the two GRIN lenses of the cascade followed by a half wave plate HWP1 with a fast axis orientation at 45 degrees to the horizontal after the second grin lens in the cascade. Transformation module 916 consists of a pair of similar or same birefringence GRIN lenses in a cascade with an interstitial component in the form of a half wave plate HWP1 with a fast axis orientation at 0 degrees to the horizontal between the two GRIN lenses of the cascade followed by a quarter wave plate QWP1 with a fast axis orientation at 45 degrees to the horizontal after the second grin lens in the cascade. Transformation module 918 consists of a pair of similar or same birefringence GRIN lenses in a cascade with an interstitial component in the form of a half wave plate HWP1 with a fast axis orientation at 0 degrees to the horizontal between the two GRIN lenses of the cascade followed by a second half wave plate HWP2 with a fast axis orientation at 45 degrees to the horizontal after the second grin lens in the cascade. In FIG. 9e, transformation module 920 consists of a pair of similar or same birefringence GRIN lenses in a cascade with an interstitial component in the form of a quarter wave plate QWP1 with a fast axis orientation at 0 degrees to the horizontal between the two GRIN lenses of the cascade followed by a second quarter wave plate QWP2 with a fast axis orientation at 45 degrees to the horizontal after the second grin lens in the cascade. Transformation module 922 consists of a pair of similar or same birefringence GRIN lenses in a cascade with an interstitial component in the form of a quarter wave plate QWP1 with a fast axis orientation at 0 degrees to the horizontal between the two GRIN lenses of the cascade followed by a half wave plate HWP1 with a fast axis orientation at 45 degrees to the horizontal after the second grin lens in the cascade. Transformation module 924 consists of a pair of similar or same birefringence GRIN lenses in a cascade with interstitial components in the form of a quarter wave plate QWP1 with a fast axis orientation at 0 degrees to the horizontal followed by a half wave plate HWP1 with a fast axis at 45 degrees to the horizontal between the two GRIN lenses of the cascade followed by a second quarter wave plate QWP2 with a fast axis orientation at 45 degrees to the horizontal after the second grin lens in the cascade. Transformation module 926 consists of a pair of similar same birefringence GRIN lenses in a cascade with interstitial components in the form of a half wave plate HWP1 with a fast axis orientation at 45 degrees to the horizontal followed by a quarter wave plate QWP1 with a fast axis at 0 degrees to the horizontal between the two GRIN lenses of the cascade followed by a second quarter wave plate QWP2 with a fast axis orientation at 45 degrees to the horizontal after the second grin lens in the cascade.

In FIGS. 9f to 9j the second GRIN lens in the cascade of GRIN lenses has a length three times greater than the first GRIN lens in the cascade of GRIN lenses. Thus transformation module 928 consists of a pair of GRIN lenses in a cascade with no interstitial components where the second GRIN lens' birefringence value is around three times greater than that of the first GRIN lens. Transformation modules 930, 932, 934, 936, 938, 940, 942, 944, 946, 948, 950, 952 and 954 are similar to transformation modules 902, 904, 906, 908, 910, 912, 914, 916, 918, 920, 922, 924 and 926 respectively except that the second GRIN lens in the cascade of GRIN lenses has a birefringence value that is around three times greater than that of the first GRIN lens. It should be appreciated that the birefringence profile of the second GRIN lens could alternatively be any integer (or non-integer) multiple of the birefringence level of the first GRIN lens, or any birefringence profile in between.

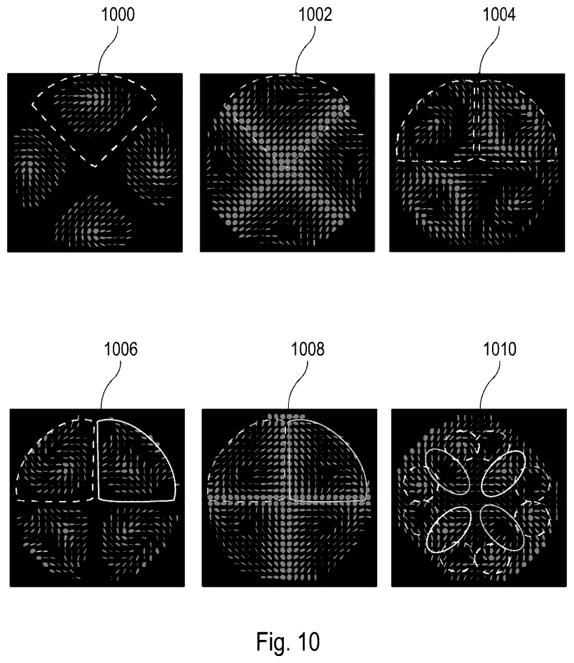

FIG. 10 shows a selection of six generated polarization patterns for further analysis taken from the results presented in FIGS. 9a to 9j. Specifically, pattern 1000 corresponds to the pattern generated by the transformation module 902 for a right hand circular incident polarization state, 1002 corresponds to the pattern generated by transformation module 918 for a right hand circular incident polarization state, pattern 1004 corresponds to the pattern generated by the transformation module 936 for a right hand circular incident polarization state, pattern 1006 corresponds to the pattern generated by transformation module 936 for a horizontal incident polarization state, pattern 1008 corresponds to the pattern generated by transformation module 948 for a horizontal incident polarization state and finally pattern 1010 corresponds to the pattern generated by transformation module 944 for a right hand circular incident polarization state. From patterns 1000 and 1002 it is evident that the GRIN lens based cascade transformation module is able to generate multiple Full Poincaré beam units within the single beam (each could have 4 units under those structures, see white and green dotted triangle to selected one unit) in a single-beam. The beams represented by patterns 1000 and 1002 also have opposite topological charge. In pattern 1004 there are two pairs of full Poincaré beams with opposite topological charge within a single overall beam (white and green dotted line show one pair) and opposite handedness on the corresponding topological charge units. In patterns 1006 and 1008 there are multiple full Poincaré beams with opposite topological charge but same handedness on the corresponding topological charge units in a single-beam (white solid and dotted lines in 1006 and green counterparts in 1008). In 1006 there are actually 2 basic topological units in one full Poincaré beam but in 1008 there is only one. This reveals that the GRIN lens based structure is able to modulate different kinds of full Poincaré beam. Pattern 1010 demonstrates not only that multi full Poincaré beam units can be generated, but also that the beam could have multi same/opposite topological charge units and multi same/opposite handedness beam units simultaneously (white circles have same handedness but could find opposite topologic charges pairs in solid and dotted circles, green circles have opposite handedness compared with the one in white circles, and could find opposite topologic charges pairs in their own solid and dotted circles). All of these characteristics indicate that the various special vector vortex beams generated by transformation modules having GRIN lens cascade structure according to the present disclosure open a new window for fundamental polarization light field research as well as further complex polarization coding/engineering.

Orbital Angular Momentum Beam Generation

The above section detailed the generation of VVBs which may contain OAM and where the polarization state is also inhomogeneous, i.e. contains structure such as a full Poincaré beam. This section is concerned with generation of OAM beams which do not have the inhomogeneous polarization structure of the above VVB beams but still contain orbital angular momentum. It has also been appreciated by the inventor that transformation modules comprising one or more GRIN lenses in a cascade structure as disclosed herein are capable of producing beams having orbital angular momentum, OAM. A light beam with a helical phase-front, described by an azimuthal phase structure of the form e^{imϑ} carries OAM equivalent to mℏ per photon.

Consider the state of polarization used in the system, presenting as a eigenbasis

$${E}_{L} = {\frac{1}{\sqrt{2}} [ 1 , - i ]}^{T} , {E}_{R} = {\frac{1}{\sqrt{2}} [ 1 , i ]}^{T} .$$

Assume, for example, that an incident polarization state

$${E}_{R} = {\frac{1}{\sqrt{2}} [ 1 , i ]}^{T}$$

is generated by we polarization state generator 402 of the arrangement 400 shown in FIG. 4 (described above). After propagating through the transformation module 404 consisting of the single GRIN lens 408 the polarization state becomes:

$${J}_{GRIN} {E}_{R} = {z}_{1} {E}_{R} + {z}_{2} {E}_{L} = {J}_{GRIN} [ \begin{matrix}1 \\ i\end{matrix} ] = {z}_{1} [ \begin{matrix}1 \\ i\end{matrix} ] + {z}_{2} [ \begin{matrix}1 \\ - i\end{matrix} ] \qquad ( 2 )$$

where J_{GRIN} is the Jones matrix of the GRIN lens given by equation (1) above. Using the Jones matrix yields expressions [z₁, z₂] in equation (2) above can be written as z₁=½(eⁱ⁰+e^{iσ}), z₂=½(e^{i(2θ+π)}+e^{i(2θ+σ)}), Accordingly, if the PSA 406 of the arrangement of FIG. 4 is arranged to select left-hand polarized light when having

$${E}_{R} = {\frac{1}{\sqrt{2}} [ 1 , i ]}^{T}$$

incident, in equation (2) only the z₂E_{L} part would remain at the output of the PSA 406, which is given by:

$$\begin{matrix}{z}_{2} {E}_{L} = \frac{1}{2} ( {e}^{i ( 2 θ + π )} + {e}^{i ( 2 θ + σ )} ) [ \begin{matrix}1 \\ - i\end{matrix} ] \\ = A {e}^{i ( 2 θ + φ )} [ \begin{matrix}1 \\ - i\end{matrix} ]\end{matrix} \qquad ( 3 )$$

Since OAM is only related to the phase profile of the beam, the intensity pre-factor A in equation (3) can be disregarded for the purposes of this analysis. Equation (3) reveals a phase factor given by i(2θ+φ), φ could be considered as corresponding to an initial phase delay determined by σ which is fixed when a GRIN lens is manufactured. The i2θ part shows that the analysed beam z₂E_{L} carries 2 units of OAM, which reveals the GRIN lens can be used as an OAM generator as well as having the ability to be a spin to orbital angular momentum converter.

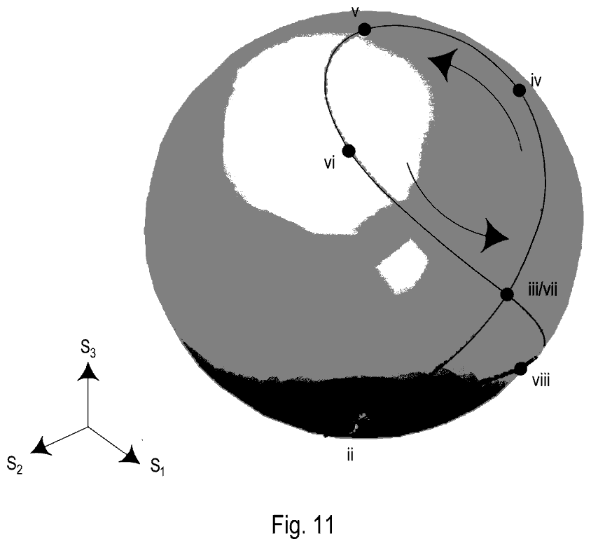

Experimental results were obtained to demonstrate the ability of the apparatus 400 shown in FIG. 4 to generate orbital angular momentum. The incident polarization state generated by the PSG 402 was fixed at right-hand circular, i.e. a spin state which carries spin angular momentum. Different analysis states were used to obtain corresponding wave front information. Specifically, by rotating the second quarter wave plate QWP2 located in the PSA section 406 of apparatus 400, whilst keeping the other polarization manipulating components fixed, a pathway of changing analysis polarization states from i to ix was obtained, as illustrated on the Poincaré sphere of FIG. 11.

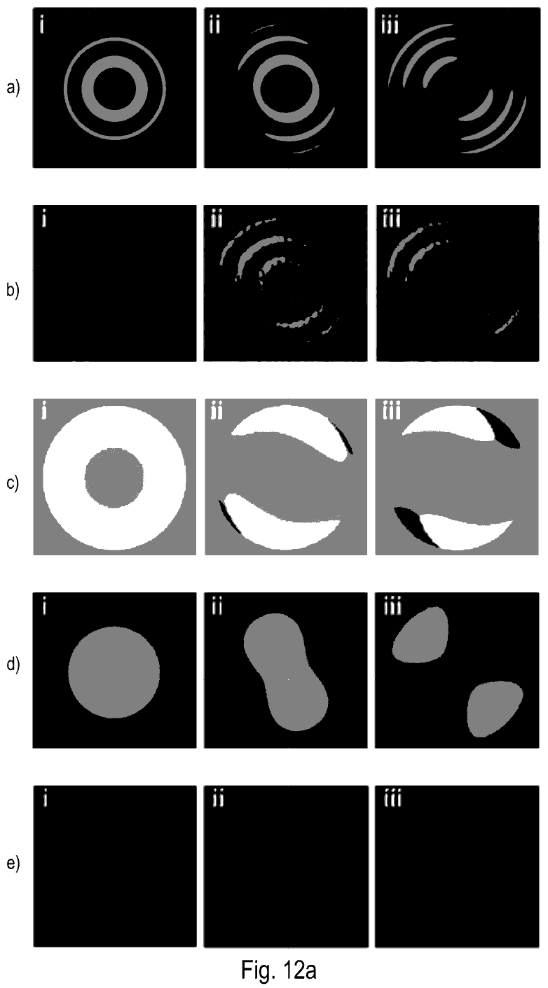

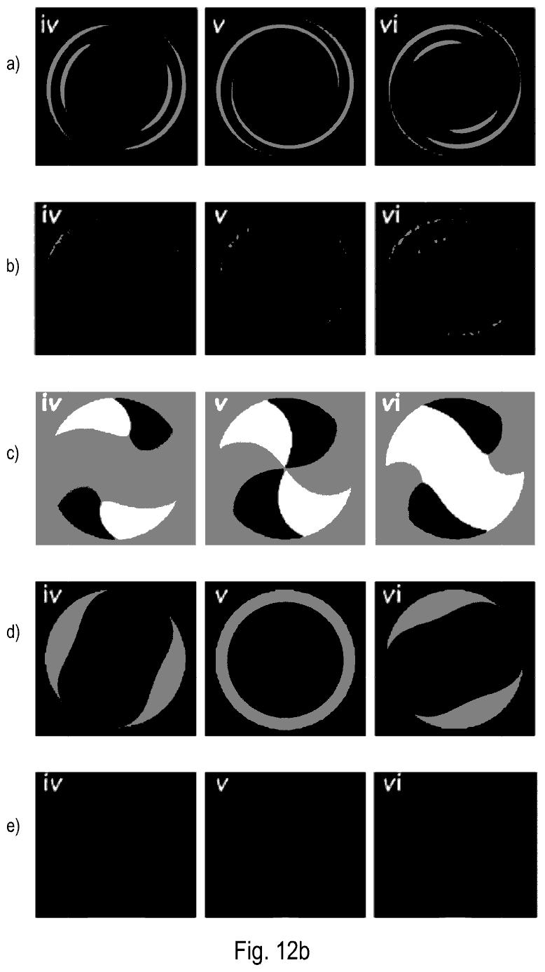

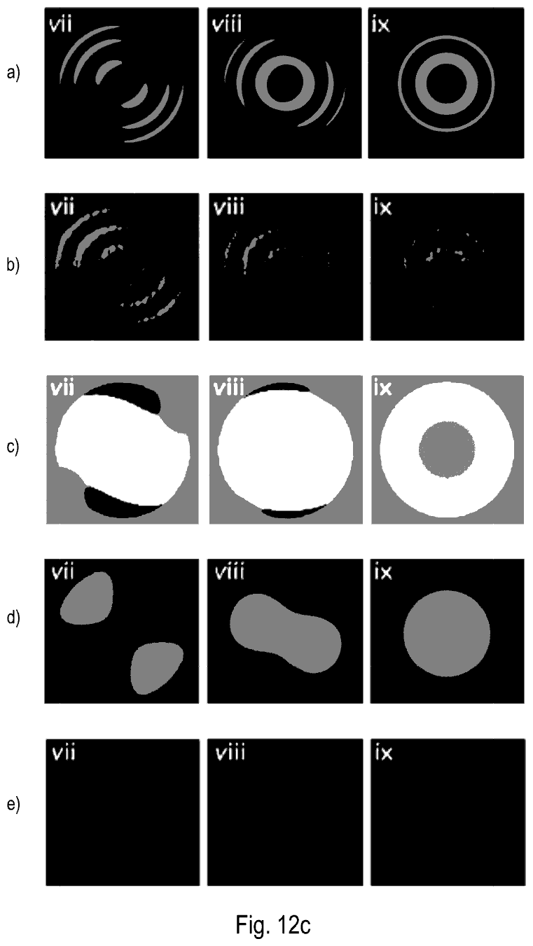

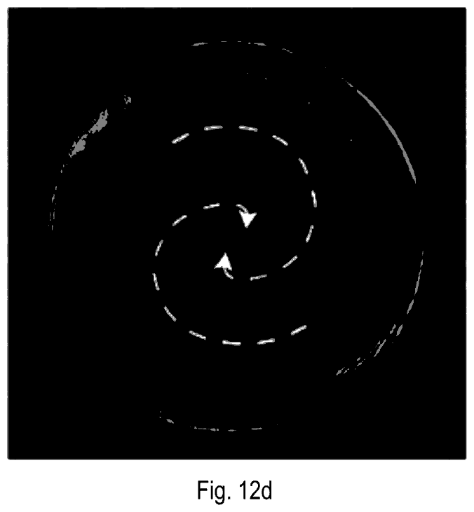

FIGS. 12a to 12c show experimental results and corresponding simulations for OAM generation at each of the analysis polarization states i to ix illustrated on the Poincaré sphere of FIG. 11. In each of FIGS. 12a, 12b and 12c, row a) shows simulated interference patterns, row b) shows experimentally obtained interference patterns, row c) shows simulated phase patterns, row d) shows simulated intensity distributions and row e) shows experimentally obtained intensity distributions. To traverse the analysis path from i to ix on the Poincaré sphere the QWP2 in the PSA 406 was rotated from −45 degrees to 135 degrees in 22.5 degree increments. FIG. 12d shows the interferometric pattern under state v in greater detail, which is obtained for right hand circular incident and opposite handedness analysis. The existence of 2 spirals in FIG. 12d (indicated by the two superimposed arrows) validates that the GRIN lens arrangement of FIG. 4 can generate 2 units of OAM when under this configuration, which also agrees well with the theoretical prediction.

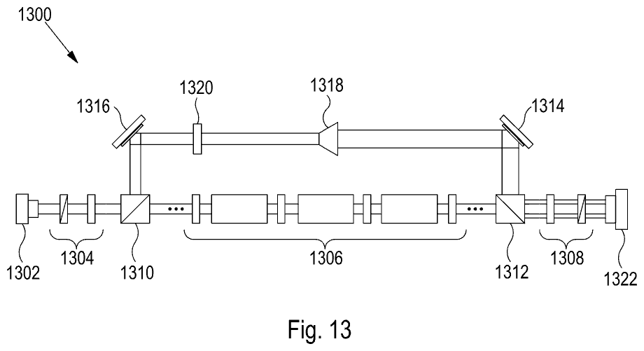

FIG. 13 illustrates in detail the experimental setup used to obtain the interference patterns shown in FIGS. 12a to 12c. It is a Mach-Zehnder type interferometer formed by a pair of beam splitters 1310 and 1312 and silver mirrors 1314 and 1316. A He—Ne laser 1302 is used as the light source (633 nm, 2 mW), a polarizer and a quarter wave plate form an effective PSG 1304 (i.e. the same as PSG 402 in FIG. 4) to generate uniform incident polarization light field into the GRIN lens based transformation module 1306 (i.e. in one case the same as transformation module 404 in FIG. 4). The light reflected by the first beam splitter 1310 is the reference beam for the reference arm, which passing by a silver mirror 1316 then is modulated by a half wave plate 1320 and a beam expander 1318. After that, the beam is reflected again by another silver mirror 1314 and then combined with the beam from the transformation module 1306 by the second beam splitter 1312. Finally, a second quarter wave plate and the polarizer form an effective PSA 1308 (i.e. the same as PSA 406 in FIG. 4) which filters the polarization state of the reference beam and beam emerging from the transformation module. This produces interference between the two beams and allows absolute phase information to be determined by recording the output light on a CCD camera 1322.

Using different transformation modules (i.e. different numbers of GRIN lenses and interstitial components as discussed above) as well as different incident and analysis polarization states enables other OAM beams to be produced. As above, the equivalent Jones Matrix of GRIN lens is equal to:

$${J}_{G R I N} = \frac{1}{2} [ \begin{matrix}{J}_{11} & {J}_{12} \\ {J}_{21} & {J}_{22}\end{matrix} ] = [ \begin{matrix}{sin}^{2} ( θ ) + {ϵcos}^{2} ( θ ) & ( ϵ - 1 ) sin ( θ ) cos ( θ ) \\ ( ϵ - 1 ) sin ( θ ) cos ( θ ) & {cos}^{2} ( θ ) + ϵ {sin}^{2} ( θ )\end{matrix} ] \qquad ( 4 )$$

where ★=e^{iσ}=cos(σ)+i sin(σ), and σ=f(r)∝nₑ(r), θ is the fast axis direction of the equivalent wave plate which equals to the azimuthal angle in the cylindrical coordinate system, r is the radius of the section of GRIN lens, σ is the linear retardance value of the equivalent wave plate at the fixed r and θ. Therefore:

J₁₁=1−cos(2θ)+cos(σ)+cos(σ)cos(2θ)+(sin(σ)+sin(σ)cos(2θ))i (5)

J₁₂=−sin(2θ)+cos(σ)sin(2θ)+sin(σ)sin(2θ)i (6)

J₂₁=−sin(2θ)+cos(σ)sin(2θ)+sin(σ)sin(2θ)i (7)

J₂₂=1+cos(2θ)+cos(σ)−cos(σ)cos(2θ)+(sin(σ)−sin(σ)cos(2θ))i (8)

Suppose a uniformly polarized beam represents by Jones Vector Eᵢₙ passes through the GRIN lens J_{GRIN}, the properties of the generated vector Eₒᵤₜ=J_{GRIN}·Eᵢₙ is examined in two specific eigenpolarization bases E₁=Span([1, 0]^{T}, [0, 1]^{T}) and E₂=Span([1, i]^{T}, [1, −i]^{T}). If the incident polarization state right hand circular then:

$${J}_{GRIN} [ \begin{matrix}1 \\ i\end{matrix} ] = {z}_{1}^{′} [ \begin{matrix}1 \\ 0\end{matrix} ] + {z}_{2}^{′} [ \begin{matrix}0 \\ 1\end{matrix} ] \qquad ( 9 )$$

Since [z₁ z₂] contains both intensity and absolute phase information, the complex intensity/phase profile can be separated into 4 discrete and ordered parts, which makes it easier for further validation and analysis of the beam composition. [z₁ z₂] can be written in exponential form as

$${z}_{1}^{′} = \frac{1}{2} ( {e}^{i 0} + {e}^{i σ} + {e}^{i ( 2 θ + π )} + {e}^{i ( σ + 2 θ )} ) , \\ {z}_{2}^{′} = \frac{1}{2} ( {e}^{i ( \frac{π}{2} )} + {e}^{i ( σ + \frac{π}{2} )} + {e}^{i 2 ( θ + \frac{π}{4} )} + {e}^{i ( σ + 2 θ \frac{π}{2} )} ) ,$$

so equation (9) can be also expressed as equation (10) below:

$${J}_{GRIN} [ \begin{matrix}1 \\ i\end{matrix} ] = \frac{1}{2} ( {e}^{i 0} + {e}^{i σ} + {e}^{i ( 2 θ + π )} + {e}^{i ( σ + 2 θ )} ) [ \begin{matrix}1 \\ 0\end{matrix} ] + \frac{1}{2} ( {e}^{i ( \frac{π}{2} )} + {e}^{i ( σ + \frac{π}{2} )} + {e}^{i 2 ( θ + \frac{π}{4} )} + {e}^{i ( σ + 2 θ \frac{π}{2} )} ) [ \begin{matrix}0 \\ 1\end{matrix} ] \qquad ( 10 )$$

The analysis under the basis E₂=Span([1, i]^{T}, [1, −i]^{T}) has been done above with an incident vector of [1, i]^{T} (i.e. right hand circular polarization incident state). If the incident vector is from the other basis E₁=Span([1, 0]^{T}, [0,1]^{T}), then horizontal linear polarized incident light [1, 0]^{T} can be chosen, then examined by E₁ and E₂ separately:

$${J}_{GRIN} [ \begin{matrix}1 \\ 0\end{matrix} ] = {z}_{1}^{″} [ \begin{matrix}1 \\ 0\end{matrix} ] + {z}_{2}^{″} [ \begin{matrix}0 \\ 1\end{matrix} ] \qquad ( 11 )$$

Then it is possible to calculate the z₁″ and z₂″ by using the same analysis process before giving:

$$\begin{matrix}{z}_{1}^{″} = \{ \begin{matrix}\frac{1}{2} ( {e}^{i 0} + {e}^{i σ} ) + \frac{1}{2} \vert cos ( 2 θ ) \vert ( {e}^{i 0} + {e}^{i ( σ + π )} ) , θ ∈ [ - \frac{3 π}{4} , - \frac{π}{4} ] ⋃ [ \frac{π}{4} , \frac{3 π}{4} ] \\ \frac{1}{2} ( {e}^{i 0} + {e}^{i σ} ) + \frac{1}{2} \vert cos ( 2 θ ) \vert ( {e}^{i π} + {e}^{i σ} ) , Otherwise\end{matrix} & ( 12 ) \\ {z}_{2}^{″} = \{ \begin{matrix}\frac{1}{2} \vert sin ( 2 θ ) \vert ( {e}^{i 0} + {e}^{i ( σ + π )} ) , θ ∈ [ - \frac{π}{2} , 0 ] ⋃ [ \frac{π}{2} , π ] \\ \frac{1}{2} \vert sin ( 2 θ ) \vert ( {e}^{i π} + {e}^{i σ} ) , Otherwise\end{matrix} & ( 13 )\end{matrix}$$

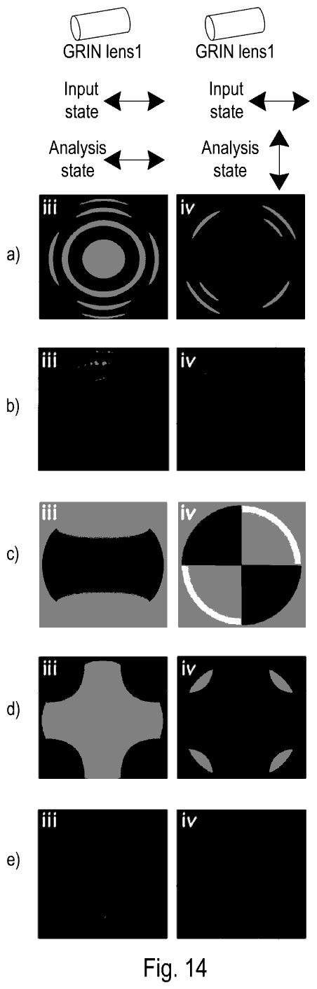

FIG. 14 shows the phase profiles, intensity distributions as well as the interference patterns (superposed by same polarized light with uniform plane wave front) for the beams with profiles z₂″ and z₁″. Rows (a) to (e) correspond to: simulated interference patterns, experimental interference patterns, simulated absolute phase profiles, simulated intensity distributions and experimental intensity distributions respectively for the indicated polarization states and GRIN lens cascade (i.e. single GRIN lens transformation module for the results shown in FIG. 14). The results also show that the GRIN lens can generate special gradually changing but quadrant segmented ‘phase blocks’, which is taking advantage of the birefringence property of the GRIN lens.

Next, the basis E₂=Span([1, i]^{T}, [1, −i]^{T}) is used as the analysis eigenbasis yielding:

$${J}_{GRIN} [ \begin{matrix}1 \\ 0\end{matrix} ] {z}_{1}^{′′′} = [ \begin{matrix}1 \\ i\end{matrix} ] + {z}_{2}^{′′′} [ \begin{matrix}1 \\ - i\end{matrix} ] \qquad ( 14 )$$

Then z₁′″ and z₂′″ are calculated through the same procedure detailed above giving:

z₁′″=¼(eⁱ⁰+e^{iσ}+e^{-i2(θ+π)}+e^{i(σ-2θ)}) (15)

z₂′″=¼(eⁱ⁰+e^{iσ}+e^{i2(θ+π)}+e^{i(σ-2θ)}) (16)

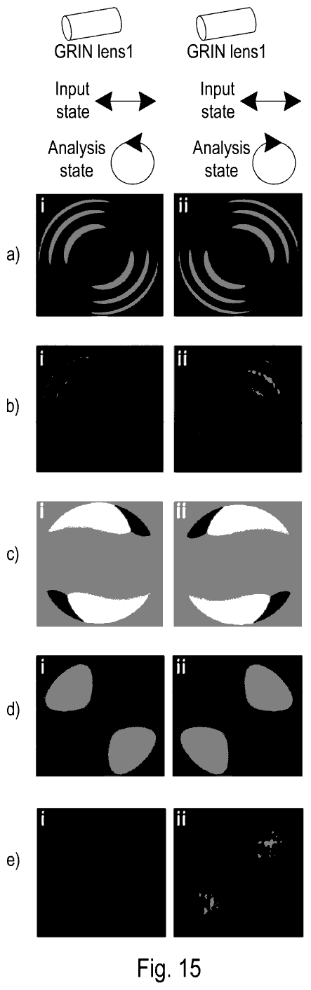

The phase profiles, intensity distributions as well as the interference patterns when using [1, i]^{T} or [1, −i]^{T} analysis is shown in FIG. 15 where the rows correspond to the same measured and simulated aspects as in FIG. 14. Again the experimental results agree well with the simulation. It should be noted that other incident eigenvectors under the basis of E₁ and E₂ can be easily calculated through the same process above. What is more, for any other eigenpolariztaion basis incident cases or analysis cases, the results also can be easily calculated based on the above analysis under the basis of E₁ and E₂.

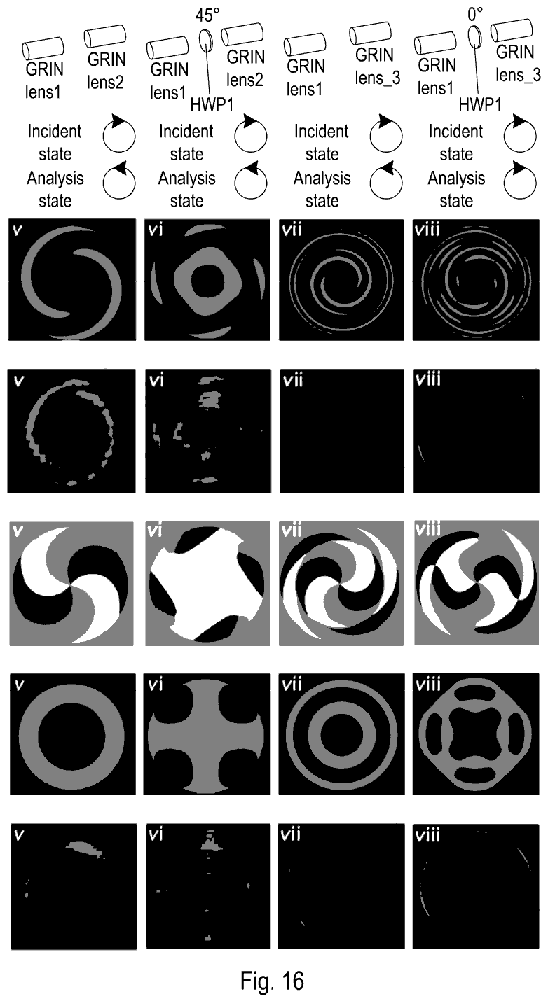

FIG. 16 shows further examples of complex absolute phase modulation through GRIN lens based structures. By choosing four typical structures, which have already been shown to generate complex structured polarization patterns in the discussion above regarding vector vortex beams, it is also demonstrated that these transformation module structures are capable of absolute phase modulation ability via eigenbasis E₂=Span([1, i]^{T}, [1, −i]^{T}). From the corresponding phase profiles, intensity distributions as well as the interference patterns in FIG. 16 it is validated that the GRIN lens based structure is able to generate complex structured absolute phase profiles.

Single-Shot Mueller Matrix Polarimetry

Among various polarimetry techniques, Mueller matrix polarimetry is advantageous because it is capable of extracting comprehensive polarization properties of the sample under investigation. Mueller matrix polarimeters are normally designed based on time-sequentially generating and analysing different states of polarization of light by rotating polarization components or modulating variable retarders in the PSG and PSA of an apparatus. However, in general time sequential measurement is not suitable for fast moving object detection, as it leads to unexpected measurement errors, and hence would have limitation when applying it to in vivo detection to assist in clinical diagnosis.

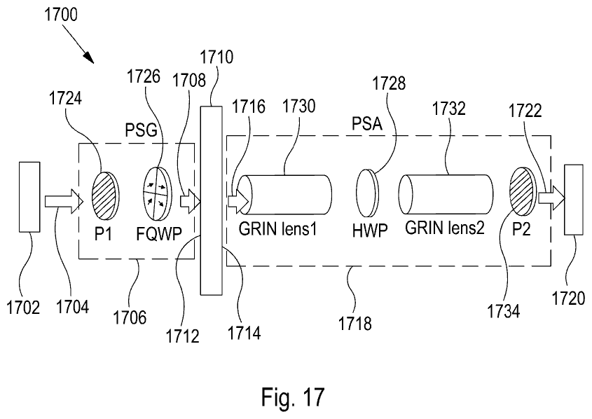

The inventor has appreciated that the GRIN lens cascade structure disclosed herein can be used as the basis for a single-shot Mueller matrix polarimeter 1700, an example of which is illustrated in FIG. 17, and comprises a light source 1702 arranged to provide a source field 1704; a polarization state generator 1706, PSG, arranged to receive the source field and provide a probe 1708 field having a plurality of spatial portions, each portion having a different polarization state; a sample region 1710 for receiving a sample under investigation, the sample region having an input 1712 arranged to receive the probe field from the PSG and an output 1714 arranged to provide a modified probe field 1716 resulting from interaction of the probe field with the sample; a polarization state analyser 1718, PSA, arranged to receive the modified probe field and to apply, to each of the plurality of portions, a set of different linear retardances and a set of different fast axis orientations; and a detector 1720 arranged to detect the plurality of portions at an output 1722 of the PSA.

In the example of FIG. 17, the PSG comprises a linear polarizer 1724 and a segmented four-quadrant quarter wave plate array 1726 (FQWP), which is able to generate four polarization states simultaneously because each segment of the plate array has a different fast axis direction. For example, the different fast axis orientations could be 0, 30, 60, −45 degrees, although it should be appreciated that there are an infinite number of combinations for the choice of the four fast axis directions and retardances of the wave plate, and that these values are only exemplary values. The PSA comprises a half wave plate 1728 sandwiched between two GRIN lenses 1730 and 1732, combined with a polarizer 1734 at the output of the second GRIN lens.

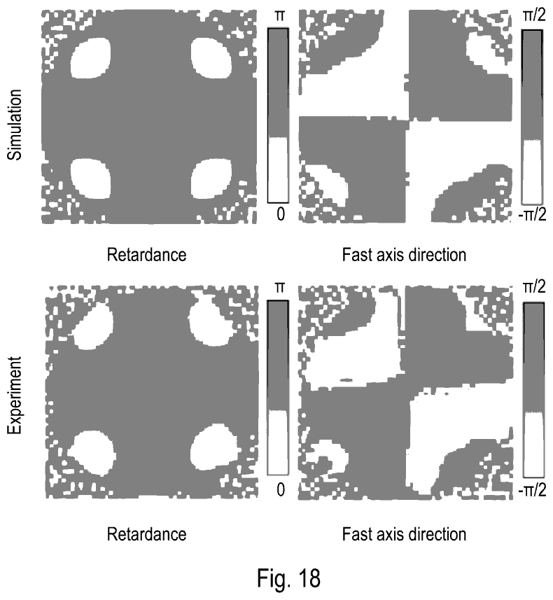

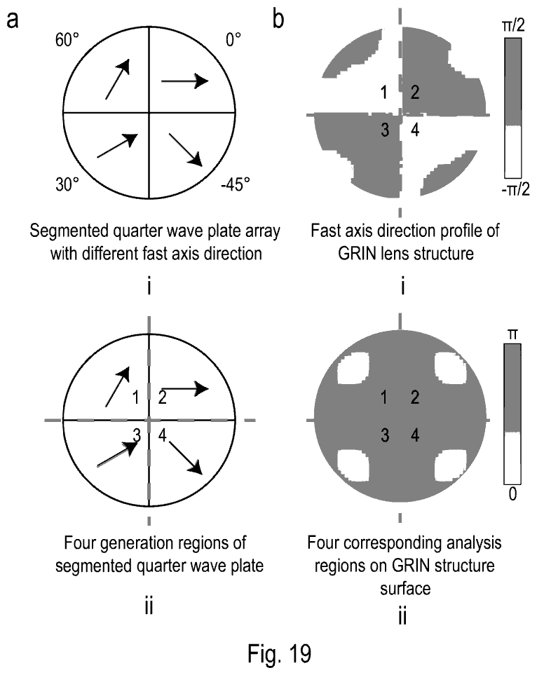

The Lu-Chipman Mueller matrix (MM) polar decomposition method (MMPD) is used to extract polarization parameters of the PSG and PSA combination shown in FIG. 17. MMPD is widely used to decompose the complicated interactions between sample and polarized light into a series processes, from which the sample's diattenuation (R), depolarisation (Δ), retardance (δ) and its fast axis direction (θ) can be obtained. The GRIN lens has no depolarization and diattenuation effect. The retardance and fast axis direction value from both simulation and experiment are shown in FIG. 18. It is found that these parameters are centrally symmetric and segmented into four channels, each of which can contain a full range of retardance and fast axis directions from 0 to π, which are therefore able to provide numerous polarization analysis channels. The multi-channels indeed allow the GRIN lens-based structure to be harnessed as a complete analyser to calculate four Stokes vectors in a single-shot. The segmented quarter wave plate array 1726 is shown in more detail in FIG. 19, panel (a). It comprises four segments of quarter wave plates with fast axes oriented at 60°, 0°, 30°, and −45. For the PSA part different ring regions from the GRIN lens surface have been chosen to calculate the Stokes vector according to the condition number. It has been found that the 132° phase retardance ring of the GRIN lens section has the lowest condition number with the measurement accuracy maximized. As shown in FIG. 19, panel (b), the polarisation characteristics under this GRIN lens structure are centrally symmetric and segmented into four quadrants, each quadrant can traverse all the retardance and fast axis directions, which means that the 132° phase retardance ring has already been included in our calculation including all the fast axis directions (the experimental GRIN lens has retardance bigger than 132°). This quality makes this structure into a multiple Stokes vectors analyser, which is what enables calculation of the Mueller matrix of the sample simultaneously.

The main equations describing the principle of operation of the MM polarimeter are derived below. Let n (n=1, 2, 3 and 4) denote the four areas of the PSG array corresponding to the four sectors of the FQWP, and m (m=4, 5, 6 . . . ) denote the chosen pixel number in each sector. The main measurement principle of the Mueller matrix polarimeter can be expressed in equations (17):

Sₒᵤₜ^{n,m}=M_{P2}·M_{GRIN2}^{n,m}·M_{HWP}·M_{GRIN1}^{n,m}·M_{Sample}·ᵢₙ^{n,m} (17)

where Sᵢₙ^{n,m} represents incident Stokes vectors generated by the four sectors of the PSG array, the m is the chosen pixel number in each sector (all pixels in each sector have the same state of polarization). Sₒᵤₜ^{n,m} is the combination of out Stokes vectors (both in the channel m of the sector n; the same meanings are followed in the later description). M_{Sample} denotes the MM of the targeted sample, and M_{P2}, M_{HWP} denote the MMs of the polarizer and the half wave plate. M_{GRIN1}^{n,m}, M_{GRIN2}^{n,m} are MMs of the GRIN lenses in the corresponding spatial positions. Since only intensity information can be recorded by the camera, which means only the first element of Sₒᵤₜ^{n,m} can be obtained (the intensity information at sector n from channel m), then Eq. (17) can be expanded into Eqs. (18) to Eq. (21) for the analysis through each channel, such that:

$$\begin{matrix}\{ \begin{matrix}{I}_{o u t}^{1 , 1} = {A}^{1 , 1} \cdot {M}_{s a m p l e} \cdot {S}_{i n}^{1 , 1} \\ {I}_{o u t}^{1 , 2} = {A}^{1 , 2} \cdot {M}_{s a m p l e} \cdot {S}_{i n}^{1 , 2} \\ {I}_{o u t}^{1 , 3} = {A}^{1 , 3} \cdot {M}_{s a m p l e} \cdot {S}_{i n}^{1 , 3} \\ {I}_{o u t}^{1 , 4} = {A}^{1 , 4} \cdot {M}_{s a m p l e} \cdot {S}_{i n}^{1 , 4} \\ ⋮ \\ {I}_{o u t}^{1 , m} = {A}^{1 , m} \cdot {M}_{s a m p l e} \cdot {S}_{i n}^{1 , m}\end{matrix} , & ( 18 ) \\ \{ \begin{matrix}{I}_{o u t}^{2 , 1} = {A}^{2 , 1} \cdot {M}_{s a m p l e} \cdot {S}_{i n}^{2 , 1} \\ {I}_{o u t}^{2 , 2} = {A}^{2 , 2} \cdot {M}_{s a m p l e} \cdot {S}_{i n}^{2 , 2} \\ {I}_{o u t}^{2 , 3} = {A}^{2 , 3} \cdot {M}_{s a m p l e} \cdot {S}_{i n}^{2 , 3} \\ {I}_{o u t}^{2 , 4} = {A}^{2 , 4} \cdot {M}_{s a m p l e} \cdot {S}_{i n}^{2 , 4} \\ ⋮ \\ {I}_{o u t}^{2 , m} = {A}^{2 , m} \cdot {M}_{s a m p l e} \cdot {S}_{i n}^{2 , m}\end{matrix} & ( 19 ) \\ \{ \begin{matrix}{I}_{o u t}^{3 , 1} = {A}^{3 , 1} \cdot {M}_{s a m p l e} \cdot {S}_{i n}^{3 , 1} \\ {I}_{o u t}^{3 , 2} = {A}^{3 , 2} \cdot {M}_{s a m p l e} \cdot {S}_{i n}^{3 , 2} \\ {I}_{o u t}^{3 , 3} = {A}^{3 , 3} \cdot {M}_{s a m p l e} \cdot {S}_{i n}^{3 , 3} \\ {I}_{o u t}^{3 , 4} = {A}^{3 , 4} \cdot {M}_{s a m p l e} \cdot {S}_{i n}^{3 , 4} \\ ⋮ \\ {I}_{o u t}^{3 , m} = {A}^{3 , m} \cdot {M}_{s a m p l e} \cdot {S}_{i n}^{3 , m}\end{matrix} , & ( 20 ) \\ \{ \begin{matrix}{I}_{o u t}^{4 , 1} = {A}^{4 , 1} \cdot {M}_{s a m p l e} \cdot {S}_{i n}^{4 , 1} \\ {I}_{o u t}^{4 , 2} = {A}^{4 , 2} \cdot {M}_{s a m p l e} \cdot {S}_{i n}^{4 , 2} \\ {I}_{o u t}^{4 , 3} = {A}^{4 , 3} \cdot {M}_{s a m p l e} \cdot {S}_{i n}^{4 , 3} \\ {I}_{o u t}^{4 , 4} = {A}^{4 , 4} \cdot {M}_{s a m p l e} \cdot {S}_{i n}^{4 , 4} \\ ⋮ \\ {I}_{o u t}^{4 , m} = {A}^{4 , m} \cdot {M}_{s a m p l e} \cdot {S}_{i n}^{4 , m}\end{matrix} & ( 21 )\end{matrix}$$

Then suppose a vector is defined such that:

Iₒᵤₜ=[Iₒᵤₜ^{1,1} . . . Iₒᵤₜ^{1,m} Iₒᵤₜ^{2,1} . . . Iₒᵤₜ^{2,m} Iₒᵤₜ^{3,1} . . . Iₒᵤₜ^{3,m} Iₒᵤₜ^{4,1} . . . Iₒᵤₜ^{4,m}]^{T} (22)

which is the intensity information recorded by the camera for each modulation and detection channel. And also let

A=[A^{1,1} . . . A^{1,m} A^{2,1} . . . A^{2,m} A^{3,1} . . . A^{3,m} A^{4,1} . . . A^{4,m}]^{T} (23)

which is a 4m×4 matrix that comprises by A^{n,m}, i.e., each first row of the corresponding M_{P2}·M_{GRIN2}^{n,m}·M_{HWP}·M_{GRIN1}^{n,m}. Each element that in A has A^{n,m}=[a₀^{n,m} a₁^{n,m} a₂^{n,m} a₃^{n,m}]. Then expanding Sᵢₙ^{n,m}=[s₀^{n,m} s₁^{n,m} s₂^{n,m} s₃^{n,m}]^{T}, and letting

$${S}_{i n} = [ \begin{matrix}{s}_{0}^{1 , 1} & … & {s}_{0}^{1 , m} & {s}_{0}^{2 , 1} & … & {s}_{0}^{2 , m} & {s}_{0}^{3 , 1} & … & {s}_{0}^{3 , m} & {s}_{0}^{4 , 1} & … & {s}_{0}^{4 , m} \\ ⋮ & ⋱ & ⋮ & ⋮ & ⋱ & ⋮ & ⋮ & ⋱ & ⋮ & ⋮ & ⋱ & ⋮ \\ {s}_{3}^{1 , 1} & … & {s}_{3}^{1 , m} & {s}_{3}^{2 , 1} & … & {s}_{3}^{2 , m} & {s}_{3}^{3 , 1} & … & {s}_{3}^{3 , m} & {s}_{3}^{4 , 1} & … & {s}_{3}^{4 , m}\end{matrix} ] \qquad ( 24 )$$

which is 4×4m matrix that consists of columns that are individual Stokes vectors from each combination of PSG sectors and camera pixels, then equations 18 to 24 above can be combined as:

Iₒᵤₜ=A·M_{Sample}·Sᵢₙ (25)

$$\begin{matrix} {I}_{o u t} = A \cdot {M}_{S a m p l e} \cdot {S}_{i n} \\ & ( 25 ) \\ [ \begin{matrix}{I}_{o u t}^{1 , 1} \\ ⋮ \\ {I}_{o u t}^{1 , m} \\ {I}_{o u t}^{2 , 1} \\ ⋮ \\ {I}_{o u t}^{2 , m} \\ {I}_{o u t}^{3 , 1} \\ ⋮ \\ {I}_{o u t}^{3 , m} \\ {I}_{o u t}^{4 , 1} \\ ⋮ \\ {I}_{o u t}^{4 , m}\end{matrix} ] = [ \begin{matrix}{a}_{0}^{1 , 1} & {a}_{1}^{1 , 1} & & {a}_{2}^{1 , 1} & {a}_{3}^{1 , 1} \\ & & ⋮ & & \\ {a}_{0}^{1 , m} & {a}_{1}^{1 , m} & & {a}_{2}^{1 , m} & {a}_{3}^{1 , m} \\ {a}_{0}^{2 , 1} & {a}_{1}^{2 , 1} & & {a}_{2}^{2 , 1} & {a}_{3}^{2 , 1} \\ & & ⋮ & & \\ {a}_{0}^{2 , m} & {a}_{1}^{2 , m} & & {a}_{2}^{2 , m} & {a}_{3}^{2 , m} \\ {a}_{0}^{3 , 1} & {a}_{1}^{3 , 1} & & {a}_{2}^{3 , 1} & {a}_{3}^{3 , 1} \\ & & ⋮ & & \\ {a}_{0}^{3 , m} & {a}_{1}^{3 , m} & & {a}_{2}^{3 , m} & {a}_{3}^{3 , m} \\ {a}_{0}^{4 , 1} & {a}_{1}^{4 , 1} & & {a}_{2}^{4 , 1} & {a}_{3}^{4 , 1} \\ & & ⋮ & & \\ {a}_{0}^{4 , m} & {a}_{1}^{4 , m} & & {a}_{2}^{4 , m} & {a}_{3}^{4 , m}\end{matrix} ] \cdot {M}_{S a m p l e} \cdot [ \begin{matrix}{s}_{0}^{1 , 1} & … & {s}_{0}^{1 , m} & {s}_{0}^{2 , 1} & … & {s}_{0}^{2 , m} & {s}_{0}^{3 , 1} & … & {s}_{0}^{3 , m} & {s}_{0}^{4 , 1} & … & {s}_{0}^{4 , m} \\ ⋮ & ⋱ & ⋮ & ⋮ & ⋱ & ⋮ & ⋮ & ⋱ & ⋮ & ⋮ & ⋱ & ⋮ \\ {s}_{3}^{1 , 1} & … & {s}_{3}^{1 , m} & {s}_{3}^{2 , 1} & … & {s}_{3}^{2 , m} & {s}_{3}^{3 , 1} & … & {s}_{3}^{3 , m} & {s}_{3}^{4 , 1} & … & {s}_{3}^{4 , m}\end{matrix} ] & ( 26 ) \\ {M}_{S a m p l e} = {A}^{- 1} \cdot {I}_{o u t} \cdot {S}_{i n}^{- 1} & ( 27 )\end{matrix}$$

The MM of the sample can be calculated via equation (27), in which Sᵢₙ⁻¹ is the pseudo inverse matrix of Sᵢₙ, and A⁻¹ is the pseudo inverse matrix of A.

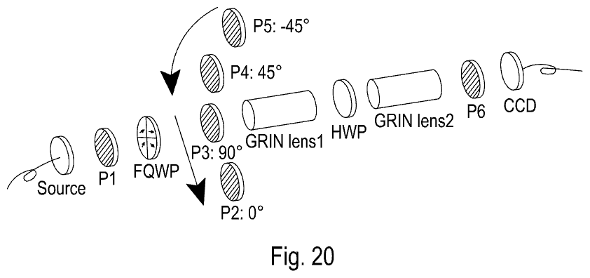

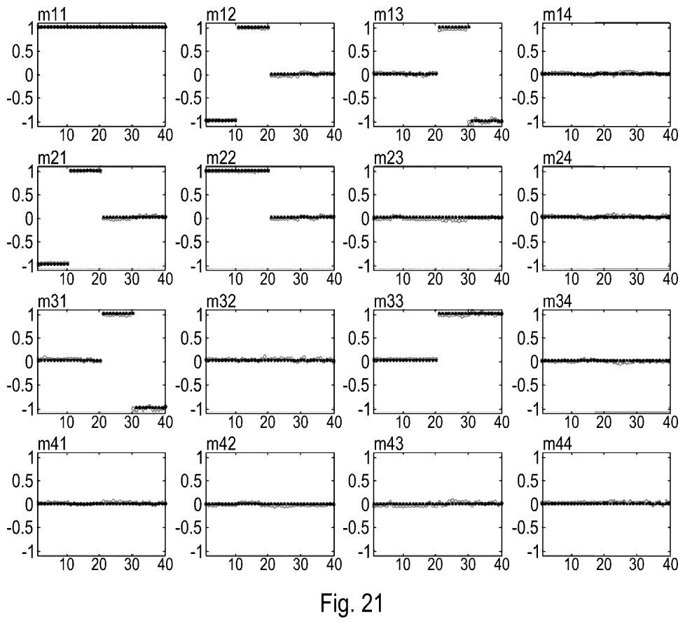

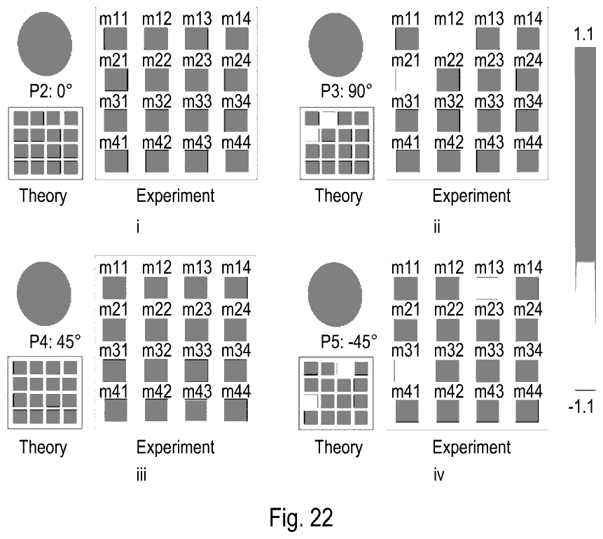

To validate the capability of the single-shot Mueller matrix polarimeter, four moving polarizers at different orientations (0, 90, 45, −45 degree) were used to simulate dynamical objects/samples under test. The experimental setup is illustrated schematically in FIG. 20. 10 points were tested for each object and the theoretical Mueller matrices were compared with the measured/reconstructed Mueller matrices for each object. The results are shown in FIG. 21 where the theoretical Mueller matrices are shown as black dots and the Mueller matrices as measured by the single-shot Mueller matrix polarimeter are shown as red dots. The horizontal axis is effectively a time axis as each test object tis moved through the sample region of the device with a different polarizer being measured for each interval of 10 units along the horizontal axis hence the steps in the values of the individual Mueller matrix elements as a different polarizer comes into the sample region of the device. The results demonstrate that the measurement of each object has an average of the maximum error of all MM elements below 3.37%. These results demonstrate that the polarimeter is capable of measuring the Mueller matrix of a moving object with a high accuracy. Since the key constituent of the device is the GRIN lens based structure, it also has a potential to be minimized and combined with other optical devices such as fibres to be made into a scanning probe, to assist with minimally invasive surgery such as detecting the boundary of cancerous tissue. FIG. 22 shows the experimental and theoretical full Mueller matrices for the four test polarizers. It is also evident that the experimental and theoretical values of the four Mueller matrices are in excellent agreement.

The condition number (CN) of a matrix is widely used to seek an optimal instrument matrix, the minimal condition number of a matrix is 1. CN is also used to evaluate the measurement precision of a polarimeter, by evaluating the instrument matrix (A^{n,m} in each sector) of it. The minimum CN of the instrument matrix of a Stokes polarimeter is 1.732. In the MM polarimeter disclosed herein, the PSA instrument matrices in each sector all reach 1.732. The instrument matrix A is a 4×4 matrix comprised by each first row of the matrices M_{QWP}ⁿ·M_{P}ⁿ, (n=1, 2, 3, 4, represents each quadrant). By using a genetic algorithm, e.g. such as that integrated in the MATLAB® optimization toolbox, an optimized CN can be found for the PSG of a MM polarimeter.

To make the instrument more simple to model it was assumed that a single input linear polarizer 1724 was used and that all wave plates are quarter wave plates. Normally to reach the lowest value of CN=1.732 a 132 degrees retardance wave plate is required which is not easy to obtain. Further, it is assumed that two of the quarter wave plates in four quadrants of the FQWP are put into 45 and −45 degrees fast axis direction. Based on this, the input linear polarizer is fixed at 0 degrees, and four quarter wave plates with fast axis orientations of 15.9, 74.1, 45, −45 degrees. That leads to a CN of 3.599. Other choices such as: 15.1, 51.7, −15.1, −51.7 degrees or 38.3, 74.9, −38.3, −74.9 degrees (for the fast axis orientation of the quarter wave plate), could both have CN of 3.40. When the condition number is small (for example around 5), there would be not a big influence on the performance of the polarimeter. For example, for the above described design case: −45, 0, 30, 60, CN is 5.887, but the measurement precision is still good. It should be appreciated that in general there are infinitely many combinations of different angles which could be chosen giving rise to different CNs. However, in general the smaller the CN the better, especially in a realistic experimental environment where noise has an impact on measurement quality.

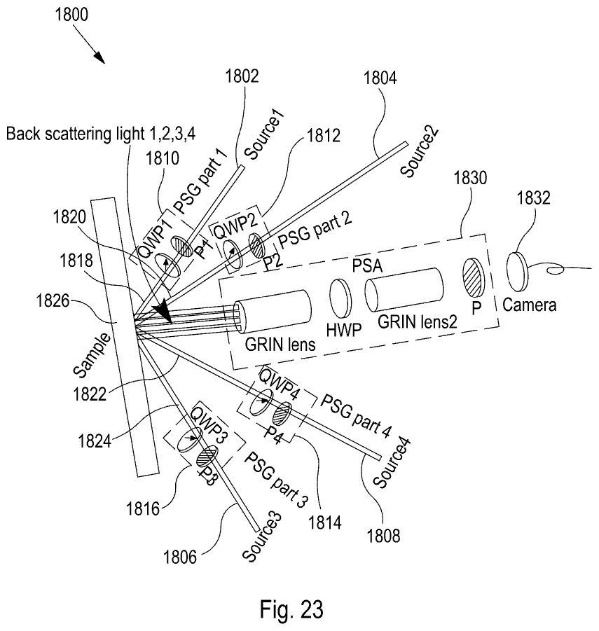

FIG. 23 illustrates an alternative arrangement 1800 for a single-shot Mueller matrix polarimeter according to the present disclosure, wherein backscattered light from the sample under investigation is measured. The mathematics describing this alternative arrangement are the same as above but the physical geometry of the device is different. Four separate source fields 1802, 1804, 1806 and 1808 are generated, e.g. from a common light source (not shown) which is split into four spatial paths or from four separate light sources (not shown). Each source field is manipulated by a corresponding polarization state generator (PSG) 1810, 1812, 1814, 1816 which each consist of a linear polarizer followed by a quarter wave plate. The PSGs are arranged to produce four separate probe fields 1818, 1820, 1822 and 1824 each having a different state of polarization. The separate probe fields are incident onto a sample 1826 under investigation which is contained in a sample region of the device which has an input arranged to receive the separate probe fields. The sample region has an output arranged to provide a modified probe field 1828 resulting from interaction of the four separate probe fields with the sample. It will be appreciated that the four separate probe fields can be considered as one overall effective probe field having a plurality of spatial portions and the modified probe fields can be considered as one overall effective modified probe field having a plurality of corresponding spatial portions, depending on how the fields are defined. The modified probe field 1828 resulting from interaction and backscattering of the probe field from the sample is then incident on a polarization state analyser 1830, PSA, arranged to receive the modified probe field and to apply, to each of the plurality of portions, a set of different linear retardances and a set of different fast axis orientations. A detector 1832 is arranged to detect the plurality of portions at an output the PSA. In this example, the PSA comprises a half wave plate sandwiched between two GRIN lenses, combined with a polarizer 1734 at the output of the second GRIN lens. Compared to the device of FIG. 17, whilst the mathematical description is effectively the same, the PSG becomes effectively 4 separately parts but these effectively correspond to the four quadrants of the PSG used in the device of FIG. 17. The PSA receives the back-reflected light from the corresponding four illuminated areas of the sample (illuminated by the corresponding PSG part). It should be appreciated that the orientation of the HWP within the PSA does not affect the relative distribution of the retardance and fast axis direction of the PSA. Overall, only the relative position of the HWP compared with the PSG distribution is of relevance. This applies to the transmission mode device of FIG. 17 and the back-reflection mode device of FIG. 23.

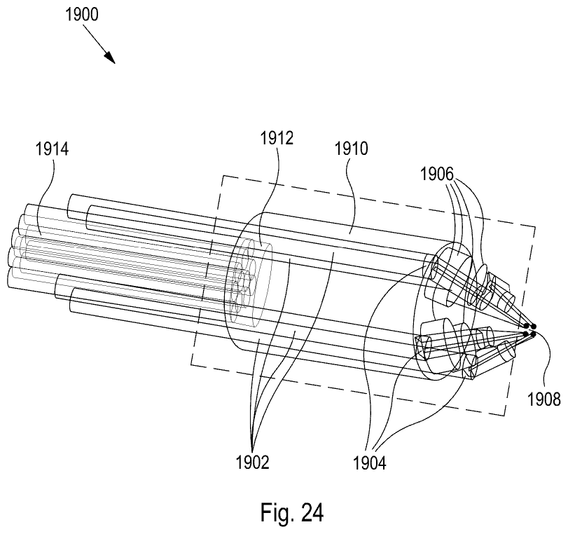

FIG. 24 illustrates a fibre-based single-shot Mueller matrix polarimeter according to the present disclosure. The principle of operation and corresponding mathematics set out above also apply to this device. A plurality of input fibres 1902 (four in the illustrated example) transmit a source field to four separate PSGs 1904, one situated at the end of each input fibre, each PSG consisting of a quarter wave plate as above with unique fast axis orientation and optionally also a linear polarizer. Focusing optics 1906, such as ball lenses, are used to focus light onto a sample 1908 under investigation. Back scattered light from the sample is then transmitted through a cascade of GRIN lenses 1910 and an output polarizer 1912 which forms the PSA of the device analogous in operation to the polarimetry devices described above. The output field of the PSA is collected by a single fibre or bundle of fibres 1914 and sent to a detector (not shown).

Further Description of GRIN Lens

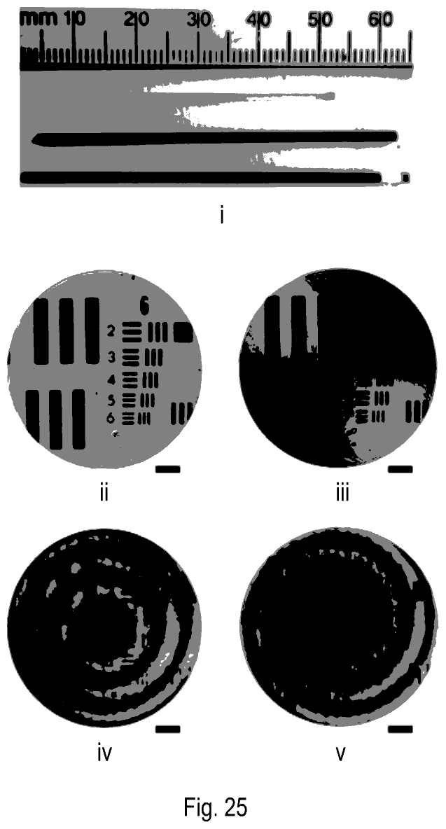

With reference to FIG. 25, panel (i) shows a commercial GRIN lens. Panel (ii) demonstrates imaging of a target by using a GRIN lens directly. Panel (iii) demonstrates obtained imaging and polarization pattern by using right hand circular polarized light incident and horizontal linear polarization state analysis, showing the GRIN lens is capable of acquiring imaging and modulation polarization simultaneously. Panel (iv) is based on (ii), another reference arm is added to gain the interference pattern to show the modulated wave front, which reveals that the GRIN lens can modulate absolute phase and polarization when obtaining imaging simultaneously. Panel (v) is a demonstration that using right hand circular polarized light as incident light (into GRIN lens) and opposite handedness analysis could obtain a light field that contains 2 units of OAM.

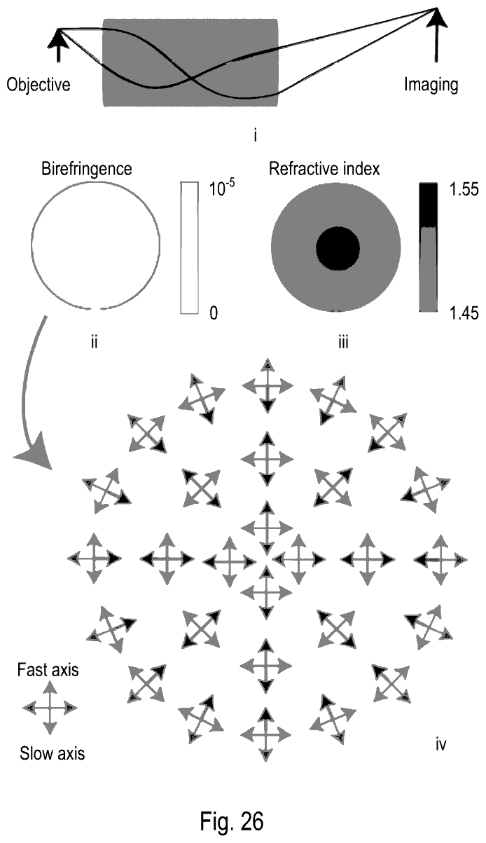

With reference to FIG. 26, panel (i) is a schematic of a GRIN lens imaging system and panels (ii) and (iii) show the birefringence and refractive index profile of a GRIN lens in cross section. Panel (iv) shows the equivalent fast axis/slow axis of the equivalent retarder contained in GRIN lens.

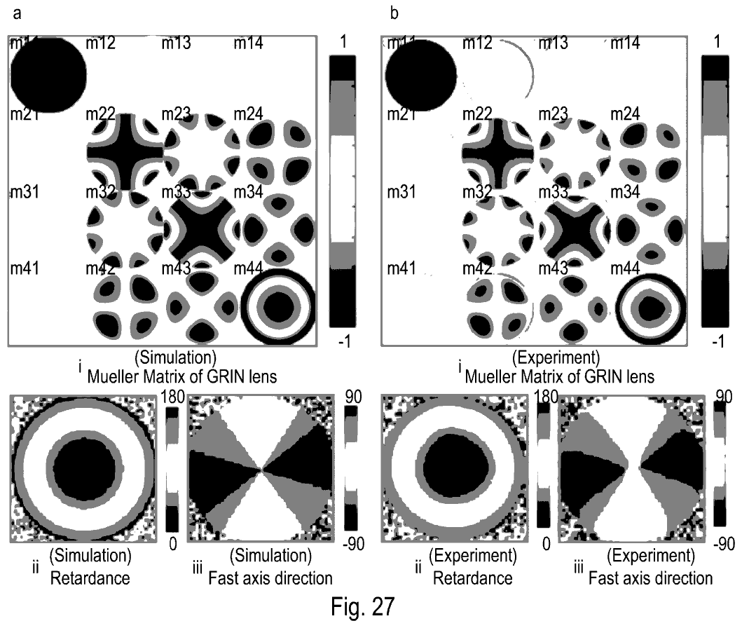

FIG. 27 shows the simulated (a) and experimental (b) Mueller matrix of a GRIN lens, panels (i), retardance, panels (ii), and fast axis direction, panels (iii). The results reveal that the birefringence property of GRIN lens can perform equivalently like a spatial-variant wave plate array with gradually increased linear retardance along the radial direction and rotated fast axis directions along azimuthal direction (gradually changing from −π/2 to 0 then to π/2 as the azimuthal angle change from 0 to π, then applying the mirror image of the fast axis directions themselves when the azimuthal angle changing from π to 2π).

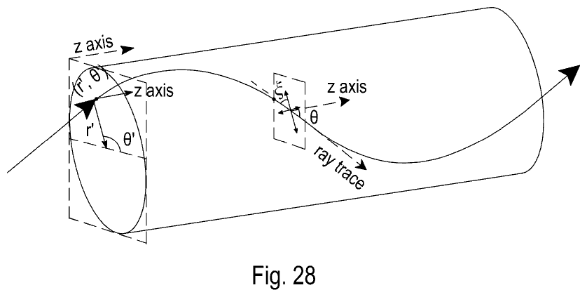

With reference to FIG. 28, for a general ray within the GRIN lens, the distance from the GRIN lens axis z is denoted by r, the azimuth of the incident position is denoted by θ, and the interior angle between the wave normal and the axis z is denoted by ξ. Then one specific incident point can be expressed as (r′, θ′, ξ′). With traditional GRIN lens ray trace format, the ray path C (which represents the radius at distance z) can be represented by P(z), where z is the propagation direction and A is a constant determined by manufacture process,

$$\frac{2 π}{\sqrt{A}}$$

is the period and amplitude is

$$\begin{matrix}\sqrt{{r}^{2} + \frac{{tan}^{2} ϛ}{A}} . & \\ \begin{matrix}C ( z ) = {r}^{′} cos ( \sqrt{A} z ) + \frac{tan {ϛ}^{′}}{\sqrt{A}} sin ( \sqrt{A} z ) \\ = \sqrt{{r}^{′2} + \frac{{tan}^{2} {ϛ}^{′}}{A}} cos ( \sqrt{A} z - {tan}^{- 1} \frac{tan {ϛ}^{′}}{\sqrt{A} {r}^{′}} )\end{matrix} & ( 25 )\end{matrix}$$

The refractive index of the o rays and e rays are denoted by nₒ and nₑ respectively, which are functions of the radius r. Then it is possible to express the refractive index of a GRIN lens in a series form as shown in Eq. 26 below:

nₒ(r)=nₒ(0)+α₁r+α₂r²+α₃r³+ . . . +αₖr^{k},(k=1,2,3, . . . )

nₑ(r)=nₑ(0)+β₁r+β₂r²+β₃r³+ . . . +βₖr^{k},(k=1,2,3, . . . ) (26)

Where nₒ(r) and nₑ(r) are the refractive indexes of the o rays and e rays at the centre, and α₁, α₂, α₃, . . . αₖ and β₁, β₂, β₃ . . . βₖ are the constants undetermined by the manufacturing process. The effective refractive index (nₑₑ(r, ξ)) of the e rays at the local position (r, θ, ξ) inside the GRIN lens is represented by:

$${n}_{e e} ( r , ξ ) = \frac{{n}_{e} ( r ) {n}_{o} ( r )}{\sqrt{{n}_{e}^{2} ( r ) {cos}^{2} ξ + {n}_{o}^{2} ( r ) {sin}^{2} ξ}} \qquad ( 27 )$$

Where ξ is the interior angle between the wave normal and the extraordinary axis, which is a complementary angle to c inside the GRIN lens. Because of the different refractive index and cosine ray trace, there will be a total phase difference σ between the o rays and e rays when the beam reaches the back surface of the GRIN lens. Combined with the equation of its ray trace in the traditional study, i.e., Eq. (25), when the refractive index varies along the optical path, the difference in optical path length (D) can be described by:

D(r,θ,ξ)≈∫_{C}(nₑₑ(s)−nₒ(s))ds (28)

Here nₑₑ(s) and nₒ(s) are the local refractive index of e rays and o rays, as a function of distance s along the optical path C from the original point (on the front surface) to the back surface. Since the birefringence in GRIN lens is very small, an approximation can be used to let both C of e rays and o rays be the same. Since paralleled incident light (ξ=0) is used in this disclosure, when r is determined at any position, θ will not affect the corresponding σ since it is θ independent under this condition, and if the wavelength of the incident beam is defined as A (choosing the integer pitch number N (N=1, 2, 3 . . . ) of GRIN lens for simplify), the overall obtained retardance σ of the corresponding point on GRIN lens back surface can be given as:

σ(r)=2π·D(r)/λ (29)

The simulation processes corresponding to the GRIN lens in this disclosure are all based on the above Eqs. (25) to (29). It is noted that the simulation results match very well with the experimental cases.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality and reference signs in the claims shall not be construed as limiting the scope of the claims.

1. An apparatus for generating vector vortex beams (VVB) that comprise non-uniform polarization states and orbital angular momentum (OAM), the apparatus comprising:
a light source arranged to provide a source field;
a polarization state generator, PSG, arranged to manipulate the source field to provide a modified field having a single polarization state; and
a transformation module arranged to receive the modified field from the PSG and transform it to provide an output field, wherein the transformation module comprises a cascade of gradient-index, GRIN, lenses.

2. The apparatus according to claim 1, wherein the PSG comprises an input linear polarizer and an input quarter wave plate, QWP.

3. The apparatus according to claim 1, wherein the transformation module further comprises a spatially-variant half wave plate, SHWP, arranged before the cascade of GRIN lenses and after the PSG.

4. The apparatus according to claim 3, wherein the SHWP is arranged to act on the modified field to provide a field having a plurality of spatial portions, each having a different polarization state, prior to the cascade of GRIN lens.

5. The apparatus according to claim 4, wherein the SHWP is arranged to provide a field having a first spatial portion with horizontal polarization, a second spatial portion with vertical polarization, a third spatial portion with +45 degrees polarization and a fourth spatial portion with −45 degrees polarization, prior to the cascade of GRIN lenses.

6. The apparatus according to claim 1, further comprising a polarization state analyser, PSA, arranged to select a single polarization state of the output field.

7. The apparatus according to claim 6, wherein the PSA comprises an output QWP and an output linear polarizer.

8. The apparatus according to claim 1, wherein the cascade of GRIN lenses additionally comprises one or more interstitial components either between at least one pair of GRIN lenses in the cascade of GRIN lenses and/or before the cascade of GRIN lenses and/or after the cascade of GRIN lenses.

9. The apparatus according to claim 8, wherein the one or more interstitial components comprise one or more of: a quarter wave plate; a half wave plate; a spatially-variant half wave plate; a vector phase plate; or a four quadrant quarter wave plate array with four different fast axis orientations.

10. The apparatus according to claim 1, wherein the cascade of GRIN lenses comprises a pair of GRIN lenses having substantially equal birefringence profiles.

11. The apparatus according to claim 1, wherein the cascade of GRIN lenses comprises a first and second GRIN lens, wherein the second GRIN lens provides at least twice the retardance of the first GRIN lens.

12. The apparatus according to claim 1, wherein the light source comprises a light-emitting diode or a laser and, optionally, a spectral filter.

13. An apparatus for generating vector vortex beams (VVB) that comprise non-uniform polarization states and orbital angular momentum (OAM), the apparatus comprising:
a light source arranged to provide a source field;
a polarization state generator, PSG, arranged to manipulate the source field to provide a modified field having a single polarization state; and
a transformation module arranged to receive the modified field from the PSG and transform it to provide an output field, wherein the transformation module comprises a gradient-index, GRIN, lens and a spatially-variant half wave plate, SHWP, arranged between the GRIN lens and the PSG.

14. An apparatus for generating orbital angular momentum (OAM) beams that have uniform polarization states, the apparatus comprising:
a light source arranged to provide a source field;
a polarization state generator, PSG, arranged to manipulate the source field to provide a modified field having a single polarization state;
a transformation module arranged to receive the modified field from the PSG and transform it to provide an output field, wherein the transformation module comprises a gradient-index, GRIN, lens; and
a polarization state analyser, PSA, arranged to select a polarization state of the output field which is different from the polarization state of the modified field:

15. The apparatus according to claim 14, wherein the PSA is arranged to select a polarization state of the output field which has the opposite handedness to the polarization state of the modified field generated by the PSG.

16. The apparatus according to claim 14, wherein the PSG is arranged to provide a modified field having a left-hand circular polarization state or a right-hand circular polarization state and the PSA is arranged to select a right-hand circular polarization state of the output field when the PSG is arranged to provide a left-hand circular polarization state; or a left-hand circular polarization state of the output field when the PSG is arranged to provide a right-hand circular polarization state.

17. The apparatus according to claim 1, wherein the cascade of GRIN lenses comprises a first and second GRIN lens, wherein the second GRIN lens provides at least three times as much retardance as the first GRIN lens.
